(19) United States
(12) Patent Application Publication
(10) Pub. No.: US 2012/0086785 A1
(43) Pub. Date: Apr. 12, 2012

(54) Apparatus for identifying protecting, requesting, assisting and managing information

(76) Inventors: David Valin, Flushing, NY (US); Alex Socolof, Briarcliff Manor, NY (US)

(21) Appl. No.: 13/332,208

(22) Filed: Dec. 20, 2011

Related U.S. Application Data
(63) Continuation of application No. 12/653,749, filed on Dec. 17, 2009, now abandoned.

(51) Int. Cl. H04N 13/02; H04N 7/18

(52) U.S. Cl. 348/47; 348/158; 348/E07.085; 348/E13.074

(57) ABSTRACT

The presented invention is an apparatus for human identification; registration; and protection executed in combination by a mobile device and a computer comprising: a mobile device consisting of a camera for capturing and recording video and audio data; a server for receiving video streamed to it by the mobile device for sign-up or sign-in; working from a computer or mobile device and using an Internet connection; accessing an authentication unit. The authentication unit creating data for registration. The authentication unit also creating identification data; and sending to verification; a match combined with 9 out of 17 positive point evaluations returns, via an Internet connection to the mobile device.

### CROSS REFERENCE TO RELATED APPLICATIONS

This application claims priority from and is a Continuation of U.S. patent application Ser. No. 12/653,749, entitled “Method and device for identifying protecting, requesting, assisting and managing information”, filed on 17 Dec. 2009, which is incorporated by reference in its entirety for all purposes as if fully set forth herein.

### SEQUENCE LISTING OR PROGRAM

Not Applicable

### FEDERALLY SPONSORED RESEARCH

Not Applicable

### TECHNICAL FIELD OF THE INVENTION

The present invention generally relates to an apparatus for registering and identifying a user in a system. More specifically the present invention relates apparatus for registering and identifying a user in a system using visual and audio means of verification.

### BACKGROUND OF THE INVENTION

The ways in which someone may be authenticated fall into three categories, based on what are known as the factors of authentication: something a user know, something a user have, or something a user are. Each authentication factor covers a range of elements used to authenticate or verify a person's identity prior to being granted access, approving a transaction request, signing a document or other work product, granting authority to others, and establishing a chain of authority.

Security research has determined that for a positive identification, elements from at least two, and preferably all three, factors be verified. The three factors (classes) and some of elements of each factor are: the ownership factors: something the user has (e.g., wrist band, ID card, security token, software token, phone, or cell phone); the knowledge factors: something the user knows (e.g., a password, pass phrase, or personal identification number (PIN), challenge response (the user must answer a question)); and the inherence factors: something the user is or does (e.g., fingerprint, retinal pattern, DNA sequence (there are assorted definitions of what is sufficient), signature, face, voice, unique bio-electric signals, or other biometric identifier).

When elements representing two factors are required for identification, the term two-factor authentication is applied . . . e.g. a bankcard (something the user has) and a PIN (something the user knows). Business networks may require users to provide a password (knowledge factor) and a pseudorandom number from a security token (ownership factor). Access to a very high security system might require a mantrap screening of height, weight, facial, and fingerprint checks (several inherence factor elements) plus a PIN and a day code (knowledge factor elements), but this is still a two-factor authentication.

Counterfeit products are often offered to consumers as being authentic. Counterfeit consumer goods such as electronics, music, apparel, and counterfeit medications have been sold as being legitimate. Efforts to control the supply chain and educate consumers to evaluate the packaging and labeling help ensure that authentic products are sold and used. Even security printing on packages, labels, and nameplates, however, is subject to counterfeiting.

One familiar use of authentication and authorization is access control. A computer system that is supposed to be used only by those authorized must attempt to detect and exclude the unauthorized. Access to it is therefore usually controlled by insisting on an authentication procedure to establish with some degree of confidence the identity of the user, granting privileges established for that identity. Common examples of access control involving authentication include: Asking for photoID when a contractor first arrives at a house to perform work; Using captcha as a means of asserting that a user is a human being and not a computer program; A computer program using a blind credential to authenticate to another program; Logging in to a computer; Using a confirmation E-mail to verify ownership of an e-mail address; Using an Internet banking system; and Withdrawing cash from an ATM.

In some cases, ease of access is balanced against the strictness of access checks. For example, the credit card network does not require a personal identification number for authentication of the claimed identity; and a small transaction usually does not even require a signature of the authenticated person for proof of authorization of the transaction. The security of the system is maintained by limiting distribution of credit card numbers, and by the threat of punishment for fraud.

Security experts argue that it is impossible to prove the identity of a computer user with absolute certainty. It is only possible to apply one or more tests which, if passed, have been previously declared to be sufficient to proceed. The problem is to determine which tests are sufficient, and many such are inadequate. Any given test can be spoofed one way or another, with varying degrees of difficulty.

Therefore, what is needed is a method and apparatus for proving identity of a computer or other electronic device user by applying one or more tests which are sufficient to proceed with allowing access and which are adequate in certainty of identity of a user.

### DEFINITIONS

A “human key” is a software identification file that enables a user to verify themselves to another user or a computer system. The software file of the human key enables a user to be verified and/or authenticated in a transaction and also provides tracking of the financial transaction by associating the transaction to one or more human keys which identify and authenticate a user in the system.

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and utilities.

A “software module” is a file that contains instructions. “Module” implies a single executable file that is only a part of the application, such as a DLL. When referring to an entire program, the terms “application” and “software program” are typically used.

A “software application module” is a program or group of programs designed for end users that contains one or more files that contains instructions to be executed by a computer or other equivalent device.

A “website”, also written as Web site, web site, or simply site, is a collection of related web pages containing images, videos or other digital assets. A website is hosted on at least one web server, accessible via a network such as the Internet or a private local area network through an Internet address known as a Uniform Resource Locator (URL). All publicly accessible websites collectively constitute the World Wide Web.

A “web page”, also written as webpage is a document, typically written in plain text interspersed with formatting instructions of Hypertext Markup Language (HTML, XHTML). A web page may incorporate elements from other websites with suitable markup anchors.

Web pages are accessed and transported with the Hypertext Transfer Protocol (HTTP), which may optionally employ encryption (HTTP Secure, HTTPS) to provide security and privacy for the user of the web page content. The user's application, often a web browser displayed on a computer, renders the page content according to its HTML markup instructions onto a display terminal. The pages of a website can usually be accessed from a simple Uniform Resource Locator (URL) called the homepage. The URLs of the pages organize them into a hierarchy, although hyperlinking between them conveys the reader's perceived site structure and guides the reader's navigation of the site.

A “mobile device” is a generic term used to refer to a variety of devices that allow people to access data and information from where ever they are. This includes cell phones and other portable devices such as, but not limited to, PDAs, Pads, smartphones, and laptop computers.

“Netbot” is an automated or semi-automated tool that can carry out repetitive and mundane tasks.

“NFC” is an acronym for “Near Field Communication” which allows for simplified transactions, data exchange, and wireless connections between two devices in proximity to each other, usually by no more than a few centimeters. NFC is expected to become a widely used system for making payments by smartphone in the United States. Many smartphones currently on the market already contain embedded NFC chips that can send encrypted data a short distance (“near field”) to a reader located, for instance, next to a retail cash register. Shoppers who have their credit card information stored in their NFC smartphones can pay for purchases by waving their smartphones near or tapping them on the reader, rather than using the actual credit card.

“Social network sites” are web-based services that allow individuals to (1) construct a public or semi-public profile within a bounded system, (2) articulate a list of other users with whom they share a connection, and (3) view and traverse their list of connections and those made by others within the system. The nature and nomenclature of these connections may vary from site to site. While we use the terms “social network”, “social network pages”, and “social network site” to describe this phenomenon, the term “social networking sites” also appears in public discourse, and the variation of terms are often used interchangeably.

“VAR” is a Virtual, live, direct or indirect, view of a physical, real-world environment whose elements are augmented by computer-generated sensory input such as sound, video, graphics or GPS data.

### SUMMARY OF THE INVENTION

The presented invention is an apparatus for human identification; registration; and protection executed in combination by a mobile device and a computer comprising: a mobile device consisting of a camera for capturing and recording video and audio data; a server for receiving video streamed to it by the mobile device for sign-up or sign-in; working from a computer or mobile device and using an Internet connection; accessing an authentication unit. The authentication unit creating data for registration. The authentication unit also creating identification data; and sending to verification; a match combined with 9 out of 17 positive point evaluations returns, via an Internet connection to the mobile device.

In alternative embodiments of the invention, the system and apparatus can use a mobile device equipped with projection means to project images or data stored in the system database for use by the identified user. In other alternative embodiments, the system and apparatus can use multiple probes or sensors for submitting information to the system from an identified source for re-distribution.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIGS. 1a-1c are embodiments of multiple smartphone devices that can be used in combination with a computer to record information and identify and authenticate user;

FIG. 2 is a USB stick storage device that may be used with the apparatus of the present invention;

FIG. 3 is a flow chart of the computer system used in combination with an input device;

FIG. 4 is a first, A processor, used in the apparatus of the present invention;

FIG. 5 is a first, B processor, used in the apparatus of the present invention;

FIG. 6 is a first, C processor, used in the apparatus of the present invention;

FIG. 7 is a first, D processor, used in the apparatus of the present invention;

FIG. 8 is a first, E processor, used in the apparatus of the present invention;

FIG. 9 is a first, F processor, used in the apparatus of the present invention;

FIG. 10 is a first, G processor, used in the apparatus of the present invention;

FIG. 11 is a first, H processor, used in the apparatus of the present invention;

FIG. 12 is a first, I processor, used in the apparatus of the present invention;

FIG. 13 is a first, J processor, used in the apparatus of the present invention;

FIG. 14 is a first, K processor, used in the apparatus of the present invention;

FIG. 15 is a first, L processor, used in the apparatus of the present invention;

FIG. 16 is a first, N processor, used in the apparatus of the present invention;

FIG. 17 is a first, O processor, used in the apparatus of the present invention;

FIG. 18 is a first, Q processor, used in the apparatus of the present invention;

FIG. 19 is a first, M processor, used in the apparatus of the present invention;

FIG. 20 is a first, U processor, used in the apparatus of the present invention;

FIG. 21 is a first, X processor, used in the apparatus of the present invention;

FIG. 22 is a first, V processor, used in the apparatus of the present invention;

FIG. 23 is a first, W processor, used in the apparatus of the present invention;

FIG. 24 is a first, R processor, used in the apparatus of the present invention;

FIG. 25 is a first, S processor, used in the apparatus of the present invention;

FIG. 26 is a first, T processor, used in the apparatus of the present invention;

FIG. 27 is a store pay station apparatus used by the present invention;

FIG. 28 is an illustration of the images and audio captures by a dual camera and microphone device of the present invention;

FIG. 29 is a saliva sensor used by an input device of the present invention;

FIG. 30 is a flow chart of the process of the present invention when used with sensors;

FIG. 31 is a projection device used with the present invention;

FIGS. 32a-32c are images of smartphone devices in combination with various sensors;

FIG. 33 is a schematic of a small sensor used in combination with the present invention;

FIG. 34 is a schematic of a probe sensor used in combination with the present invention; and

FIG. 35 is a flow chart of the system process of the present invention.

### DETAILED DESCRIPTION OF THE INVENTION

In the following detailed description, reference will be made to the accompanying drawings, in which identical functional elements are designated with like numerals. The aforementioned accompanying drawings show by way of illustration and not by way of limitation, specific embodiments and implementations consistent with principles of the present invention. These implementations are described in sufficient detail to enable those skilled in the art to practice the invention and it is to be understood that other implementations may be utilized and that structural changes and substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

The current present invention is an apparatus for identifying protecting, requesting, assisting and managing information. The apparatus is executed on a computer, laptop, mobile computing device, smartphone, or any other machine comprising the hardware components required by the apparatus of the present invention and capable of executing software to control and enable functionality of the hardware components of the apparatus of the present invention.

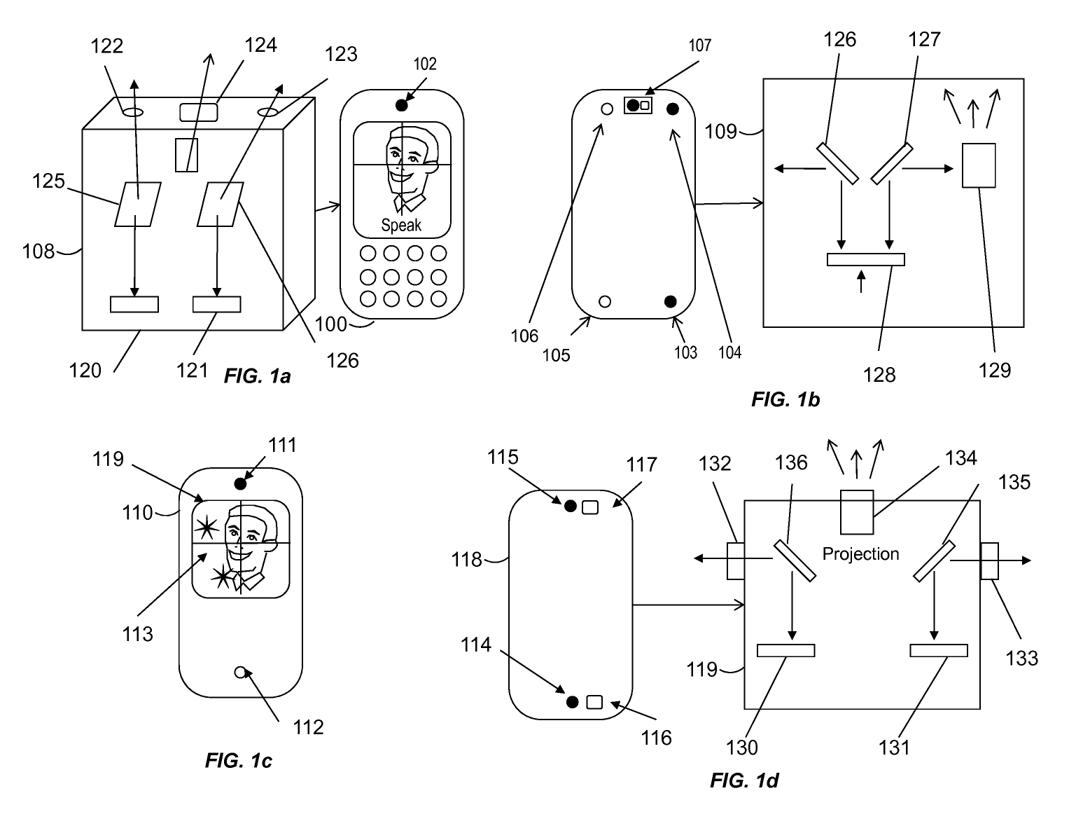

Referring to FIGS. 1a and 1b, the elements of the human key identification apparatus are shown using a smart phone device 100. In one embodiment, a smartphone device 100 is comprised of a front cam 102, back dual cams 103 and 104 a Back Single Cam with projector 107 for VAR Projection and Virtual movement detection 107, and one or more microphones 105 and 106. The smartphone is capable of audio voice print identification, video color pixel field identification 3D analysis focus point, VAR or flat field projection.

A computer laptop or mobile device such as a smartphone 100, can work with one cam split 109 or two cams in 3D mode 108 and two stereo microphones 106 and 105. A projector device 124 with two separate CCDs 120 and 121 with two separate mirrors 125 and 126 is incorporated into the smartphone device 100 in one embodiment. In another embodiment as shown in FIG. 1b, a projector device 129 with a single CCD 128 with split mirrors 126 and 126 is used in the smart phone 100.

Now referring to FIG. 1c, a mobile device such as a smartphone 110 is shown with a cam 111 and microphone 112 and crosshairs 113 on a display screen 119 with one cam 111 in front creating a single cam identification embodiment of the apparatus. The back 118 of the mobile device 111 is comprised of dual cameras 114 and 115 and dual projection lenses 116 and 117. This device embodiment using a 2 CCD 3D VAR video projection technique where the projector apparatus 119 combined within the mobile device 110.

The smartphone 110 shown in FIG. 1c is further comprised of a dual CCD 3D VAR video projection device 119. The dual CCD 3D VAR video projection device 119 is comprised of two mirrors 136 and 135 associated with one of the two CCDs 130 and 131 for projecting an image out of the projector 134.

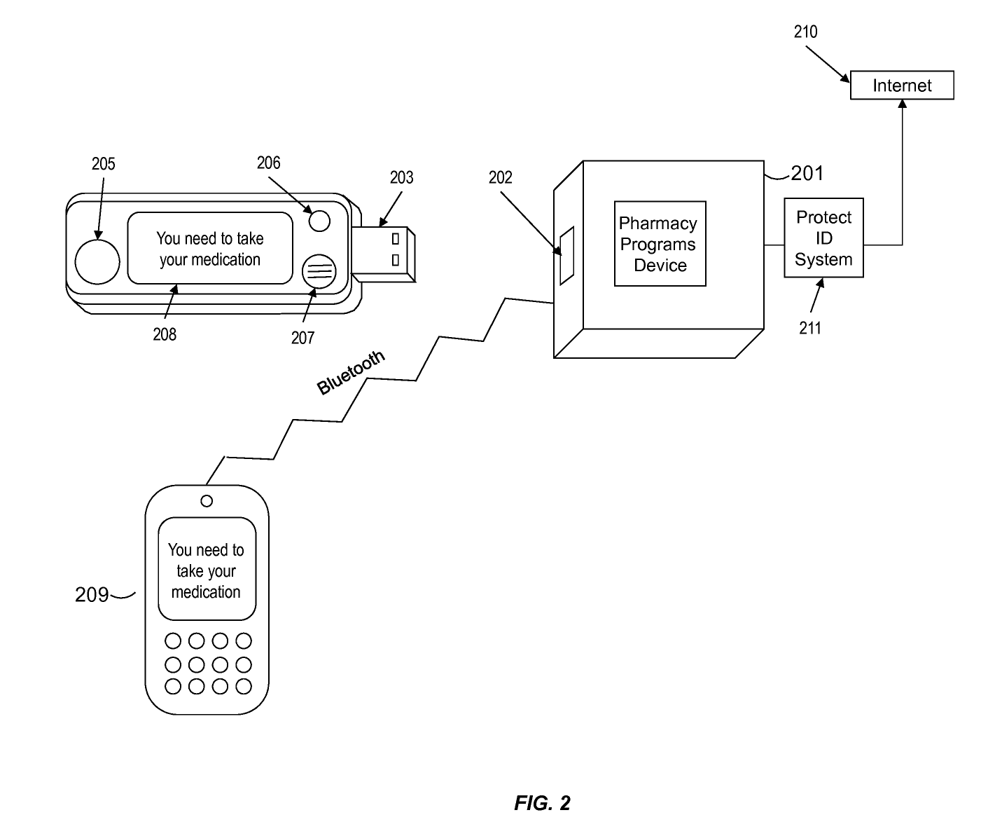

Now referring to FIG. 2, the human key audio digital fingerprint authorization apparatus is disclosed in an embodiment for use in a pharmacy. An ID protection system device 201 is provided with a USB port 202. A USB stick 203 can be plugged into the USB port 202 for the transfer of information between the USB stick 203 and the protect ID system 204 connected to the system device 201. The USB stick 203 is further comprised of a battery 205, microphone, 206, speaker 207, and display screen 208. The Pharmacy programs the device 201 when the purchase of drugs are made and suggestions and reminders are automatically presented when a person needs to take a medication. Reminders can be displaced on the USB stick 203 that is offline or sent to a computing machine such as a smart phone 209 that is connected to the device 202 using BLUETOOTH, a wireless network, or a cellular phone system. Additionally, a doctor can add pertinent information to the hardware device 201. The device 201 is connected to the ID system via the Internet 210.

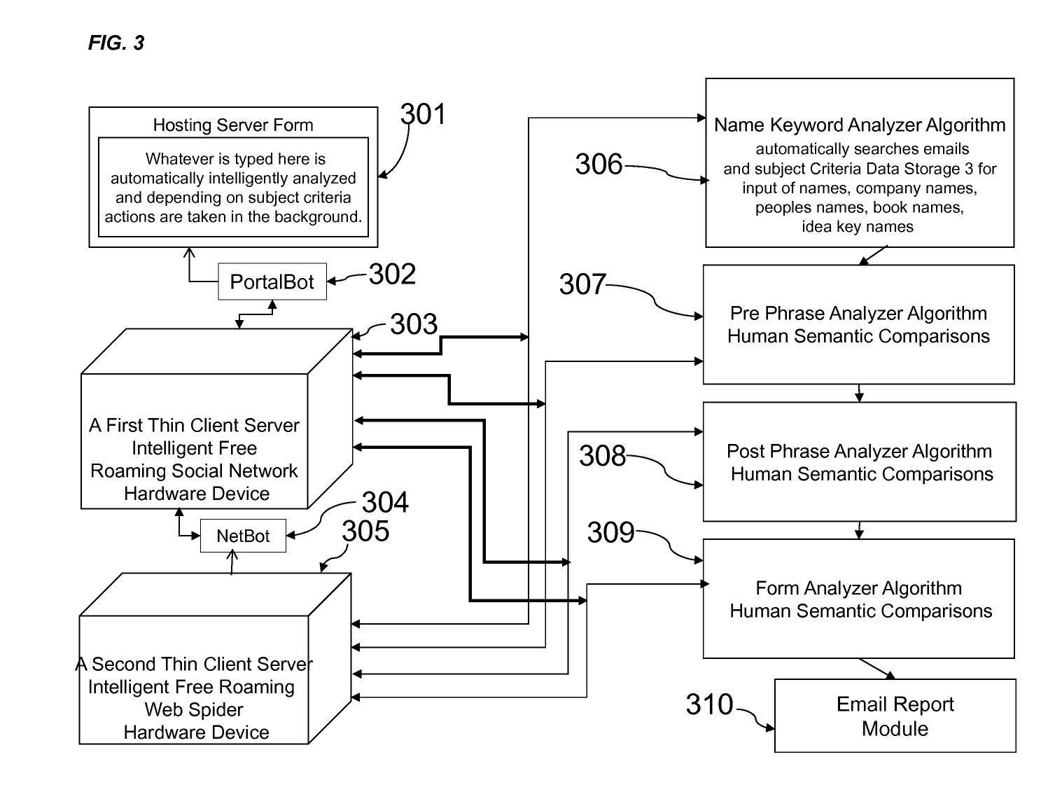

FIG. 3 illustrates how the human key is connected to email for analyzing and processing. A computer laptop or mobile device 301 provides a hosting platform where input is automatically analyzed depending on subject criteria and actions are taken in the background. A portal bot 302 is connected between the computer laptop or mobile device 301 and a first thin client server 303 which provides a roaming social network hardware device. A netbot 304 is located between a first thin client server and a second thin client server 305 which provides a roaming web spider hardware device. A Name Keyword Analyzer Algorithm automatically searches emails and subject Criteria data storage for input of names, company names, people's names, book names, idea key names 306. A Pre Phrase Analyzer Algorithm 307 provides Human Semantic Comparison 307. A Post Phrase Analyzer Algorithm provides Human Semantic Comparison 308. A Form Analyzer Algorithm provides Human Semantic Comparisons 309, which is sent to an email report module 310.

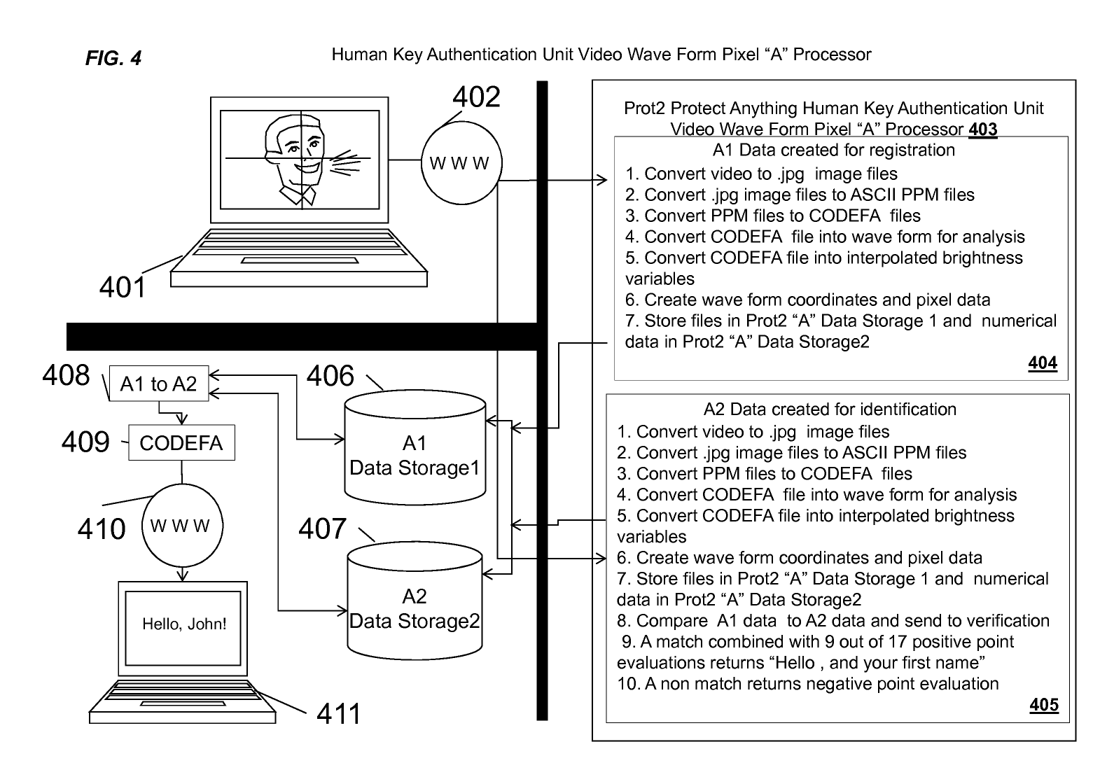

Now referring to FIG. 4, a specimen is a video recorded by a mobile device such as that disclosed in FIGS. 1a-1c and streamed to a server for sign-up or sign-in. Working from a computer or mobile device 402 and using an Internet or world wide web (WWW) connection 403, a user using a computer or mobile device 402, accessing an authentication unit 403.

The authentication unit 404 creating data for registration 404 by converting video to .jpg image files; converting .jpg image files to ASCII PPM files; converting PPM files to CODEFA files; converting CODEFA file into wave form for analysis; converting CODEFA file into interpolated brightness variables; creating wave form coordinates and pixel data; and storing files in a first data storage 406 and numerical data in a second data storage location 407.

The authentication unit 403 also creating identification data 405 by: converting video to .jpg image files; converting .jpg image files to ASCII PPM files; converting PPM files to CODEFA files; converting CODEFA files into wave form for analysis; converting CODEFA file into interpolated brightness variables; creating wave form coordinates and pixel data; storing files in a first data storage 406 and numerical data in a second data storage 407 and comparing the first data to the second data in step 408, using a Computer Object De-Encryption Encryption File Algorithm (CODEFA) 409 and sending to verification; a match combined with 9 out of 17 positive point evaluations returns 409, via an Internet or WWW connection 410, “Hello, and your first name” on a display screen of a computer 411, while a non match returns a negative point evaluation.

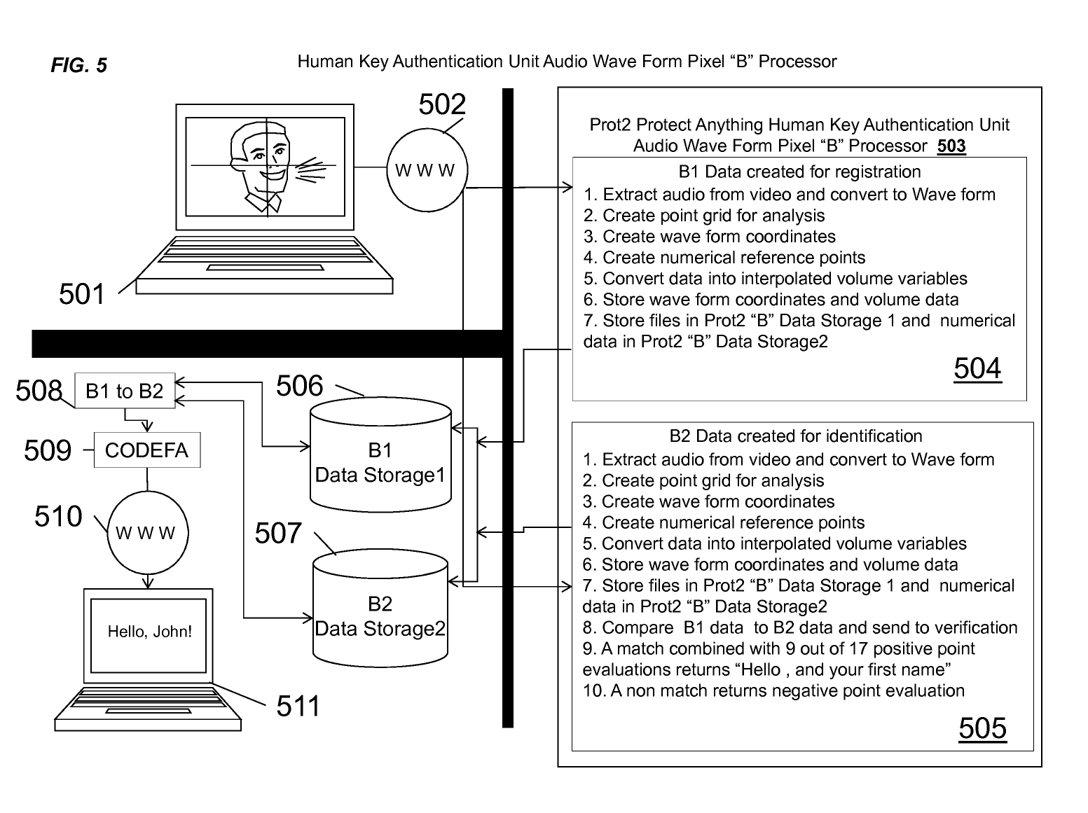

Now referring to FIG. 5, a specimen is a video recorded by a mobile device such as that disclosed in FIGS. 1a-1c and streamed to a server for sign-up or sign-in. Working from a computer or mobile device 501 and using an Internet or world wide web (WWW) connection 502, a user using a computer or mobile device 501, accessing an authentication unit 503.

The authentication unit 503 creating data for registration 504 by: extracting audio from video and converting to Wave form; creating a point grid for analysis; creating a form coordinates; creating numerical reference points; converting data into interpolated volume variables; storing wave form coordinates and volume data; and storing files in a first data storage 506 and numerical data in a second data storage 507.

The authentication unit 503 also creating data for identification 505 by: extracting audio from video and converting to Wave form; creating point grid for analysis; creating wave form coordinates creating numerical reference points; converting data into interpolated volume variables; storing form coordinates and volume data; storing files in a first data storage 506 and numerical data in a second data storage 507; comparing data stored in the databases in step 508 and sending to verification by CODEFA 509; matching combined with 9 out of 17 positive point evaluations returns via an Internet or WWW connection 510, “Hello, and your first name” on a display screen of a computer 511, while a non match returns a negative point evaluation.

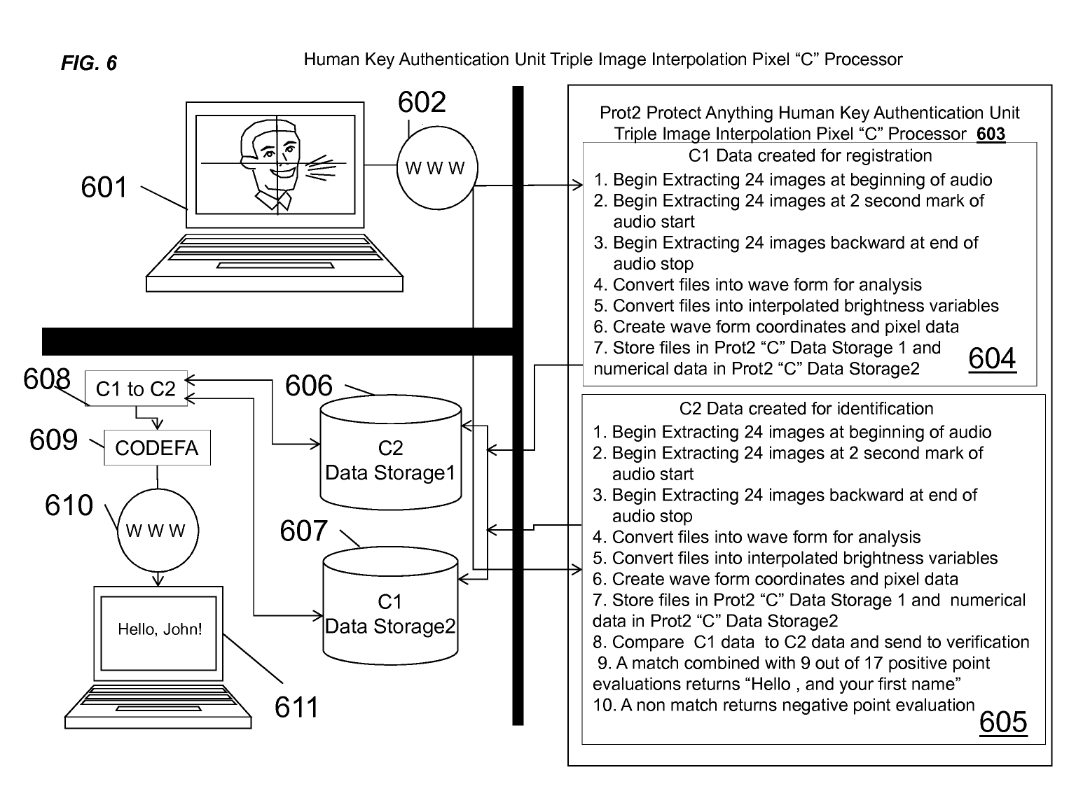

Now referring to FIG. 6, a specimen is a video recorded by a mobile device such as that disclosed in FIGS. 1a-1c and streamed to a server for sign-up or sign-in. Working from a computer or mobile device 601 and using an Internet or world wide web (WWW) connection 602, a user using a computer or mobile device 601, accessing an authentication unit 603.

The authentication unit 603 creating data for registration 604 by: extracting 24 images at beginning of audio; extracting 24 images at 2 second mark of audio start; extracting 24 images backward at end of audio stop; converting files into wave form for analysis; converting files into interpolated brightness variables; creating wave form coordinates and pixel data; and storing files in a first data storage 606 and numerical data in a second data storage 607.

The authentication unit 603 also creating data for identification 605 by: extracting 24 images at beginning of audio; extracting 24 images at 2 second mark of audio start; extracting 24 images backward at end of audio stop; converging into wave form for analysis; converting files into interpolated brightness variables; creating wave form coordinates and pixel data; storing file in a first data storage 606 and numerical data in a second data storage 607; comparing data stored in the databases in step 608 and sending to verification by CODEFA 609; matching combined with 9 out of 17 positive point evaluations returns via an Internet or WWW connection 610, “Hello, and your first name” on a display screen of a computer 611, while a non match returns a negative point evaluation.

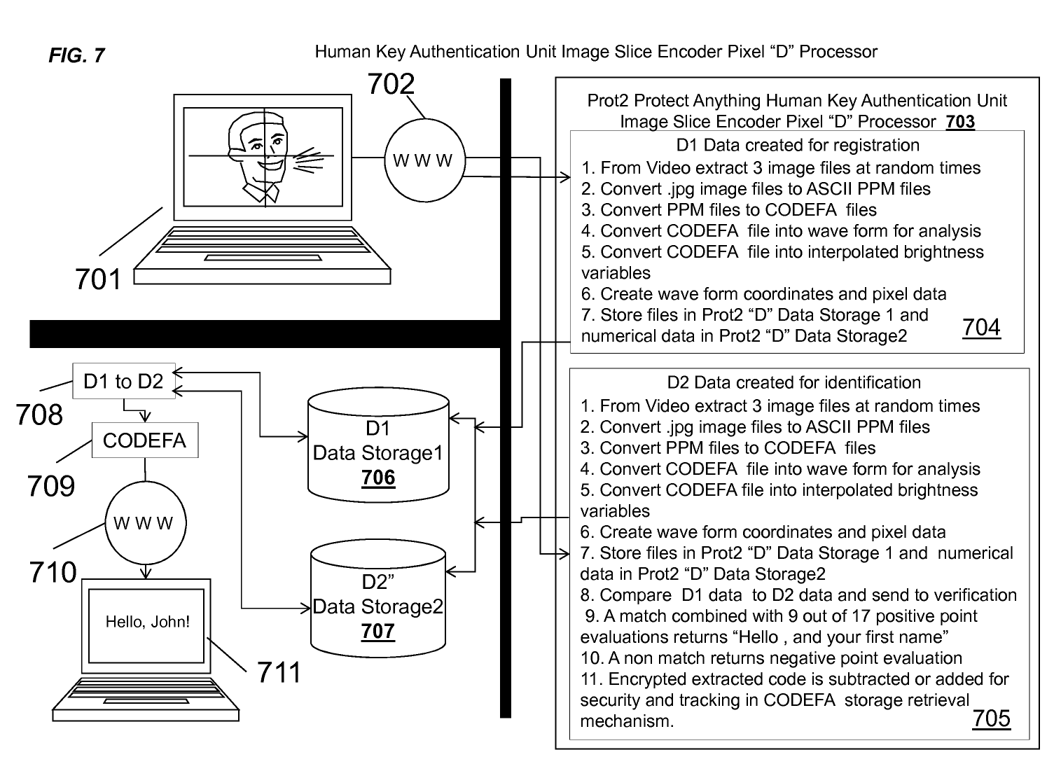

Now referring to FIG. 7, a specimen is a video recorded by a mobile device such as that disclosed in FIGS. 1a-1c and streamed to a server for sign-up or sign-in. Working from a computer or mobile device 701 and using an Internet or world wide web (WWW) connection 702, a user using a computer or mobile device 701, accessing an authentication unit 703.

The authentication unit 703 creating data for registration 704 by: extracting form the video 3 image files at random times; converting .jpg image files to ASCII PPM files; converting PPM files to CODEFA files; converting CODEFA file into wave form for analysis; converting CODEFA file into interpolated brightness variables; creating wave form coordinates and pixel data; and storing files in a first data storage 706 and numerical data in a second data storage 706.

The authentication unit 703 also creating data for identification 705 by: extracting from video 3 image files at random times; converting .jpg image files to ASCII PPM files; converting PPM files to CODEFA files; converting CODEFA file into wave form for analysis; converting CODEFA file into interpolated brightness variables; creating wave form coordinates and pixel data; storing files in a first data storage 706 and numerical data in a second data storage 707; comparing data stored in the databases and send to verification in step 708; and sending to verification by CODEFA 709; matching combined with 9 out of 17 positive point evaluations returns via an Internet or WWW connection 710, “Hello, and your first name” on a display screen of a computer 711, while a non match returns a negative point evaluation.

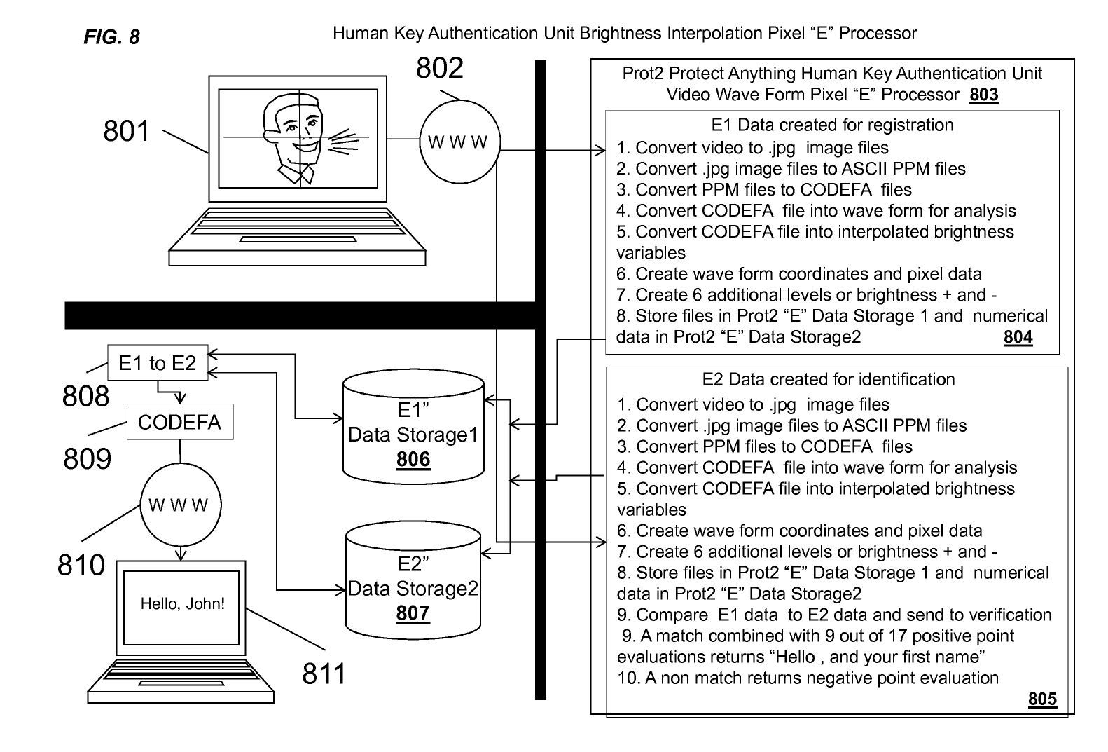

Now referring to FIG. 8, a specimen is a video recorded by a mobile device such as that disclosed in FIGS. 1a-1c and streamed to a server for sign-up or sign-in. Working from a computer or mobile device 801 and using an Internet or world wide web (WWW) connection 802, a user using a computer or mobile device 801, accessing an authentication unit 803.

The authentication unit 803 creating data for registration 804 by: converting video to .jpg image files; converting .jpg image files to ASCII PPM files; converting PPM files to CODEFA files; converting CODEFA file into wave form for analysis; converting CODEFA file into interpolated brightness variables; creating wave form coordinates and pixel data; creating 6 additional levels or brightness + and −; storing files in a first data storage 806 and numerical data in a second data storage 7.

The authentication unit 803 also creating data for identification 805 by: converting video to .jpg image files; converting .jpg image files to ASCII PPM files; converting PPM files to CODEFA files; converting CODEFA file into wave form for analysis; converting CODEFA file into interpolated brightness variables; creating wave form coordinates and pixel data; creating 6 additional levels or brightness + and −; and storing files in a first data storage 806 and numerical data in a second data storage 807; comparing data stored in the databases in step 8108 and sending to verification by CODEFA 809; matching combined with 9 out of 17 positive point evaluations returns via an Internet or WWW connection 810, “Hello, and your first name” on a display screen of a computer 811, while a non match returns a negative point evaluation.

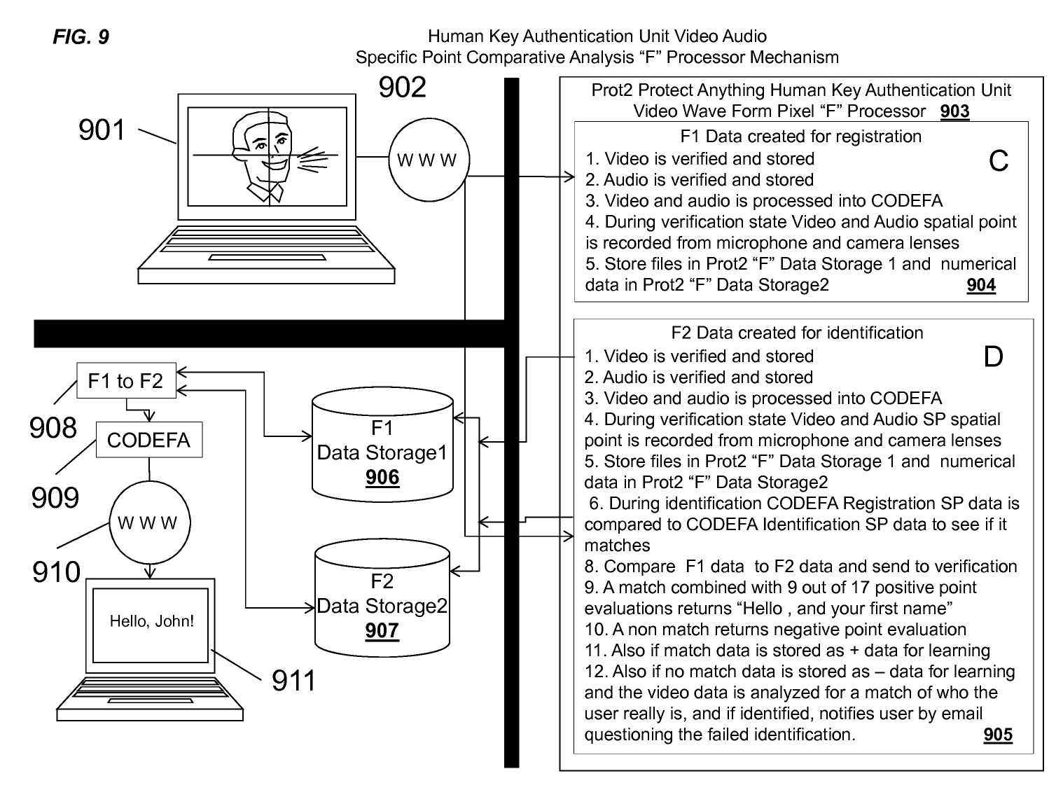

Now referring to FIG. 9, a specimen is a video recorded by a mobile device such as that disclosed in FIGS. 1a-1c and streamed to a server for sign-up or sign-in. Working from a computer or mobile device 901 and using an Internet or world wide web (WWW) connection 902, a user using a computer or mobile device 901, accessing an authentication unit 903.

The authentication unit 903 creating data for registration 904 by: Video is verified and stored; Audio is verified and stored; Video and audio is processed into CODEFA; During verification state Video and Audio spatial point is recorded from microphone and camera lenses; and storing files in a first data storage 906 and numerical data in a second data storage 907.

The authentication unit 903 also creating data for identification 905 by: Video is verified and stored; Audio is verified and stored; Video and audio is processed into CODEFA; During verification state Video and Audio SP spatial point is recorded from microphone and camera lenses; storing files in a first data storage 906 and numerical data in a second data storage 907; During identification CODEFA Registration SP data is compared to CODEFA Identification SP data to see if it matches 909; comparing data and send to verification in step 908; a match combined with 9 out of 17 positive point returns via an Internet or WWW connection 910, “Hello, and your first name” on a display screen of a computer 911. A non match returns negative point evaluation; if match data is stored as + data for learning; if no match data is stored as − data for learning and the video data is analyzed for a match of who the user really is, and if identified, notifies user by email questioning the failed identification.

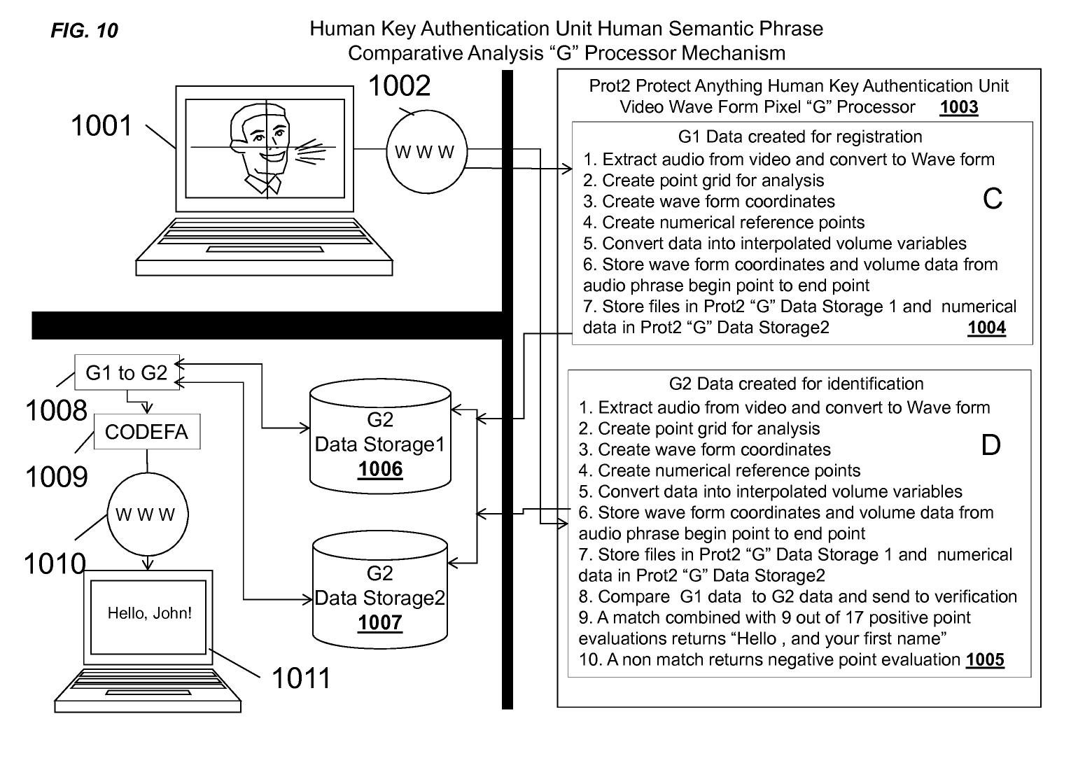

Now referring to FIG. 10, a specimen is a video recorded by a mobile device such as that disclosed in FIGS. 1a-1c and streamed to a server for sign-up or sign-in. Working from a computer or mobile device 1001 and using an Internet or world wide web (WWW) connection 1002, a user using a computer or mobile device 1001, accessing an authentication unit 1003.

The authentication unit 1003 creating data for registration 1004 by: Extracting audio from video and converting to Wave form; creating point grid for analysis; creating wave form coordinates; creating numerical reference points; converting data into interpolated volume variables; storing wave form coordinates and volume data from audio phrase begin point to end point; and storing files in a first data storage 1006 and numerical data in a second data storage 1007.

The authentication unit 1003 also creating data for identification 1005 by: Extracting audio from video and converting to Wave form; creating point grid for analysis; creating wave form coordinates; creating numerical reference points; converting data into interpolated volume variables; storing wave form coordinates and volume data from audio phrase begin point to end point; storing files in a first data storage 1006 and numerical data in a second data storage 1007; comparing data and send to verification in step 1008; and sending to verification by CODEFA 1009; matching combined with 9 out of 17 positive point evaluations returns via an Internet or WWW connection 1010, “Hello, and your first name” on a display screen of a computer 1011, while a non match returns a negative point evaluation.

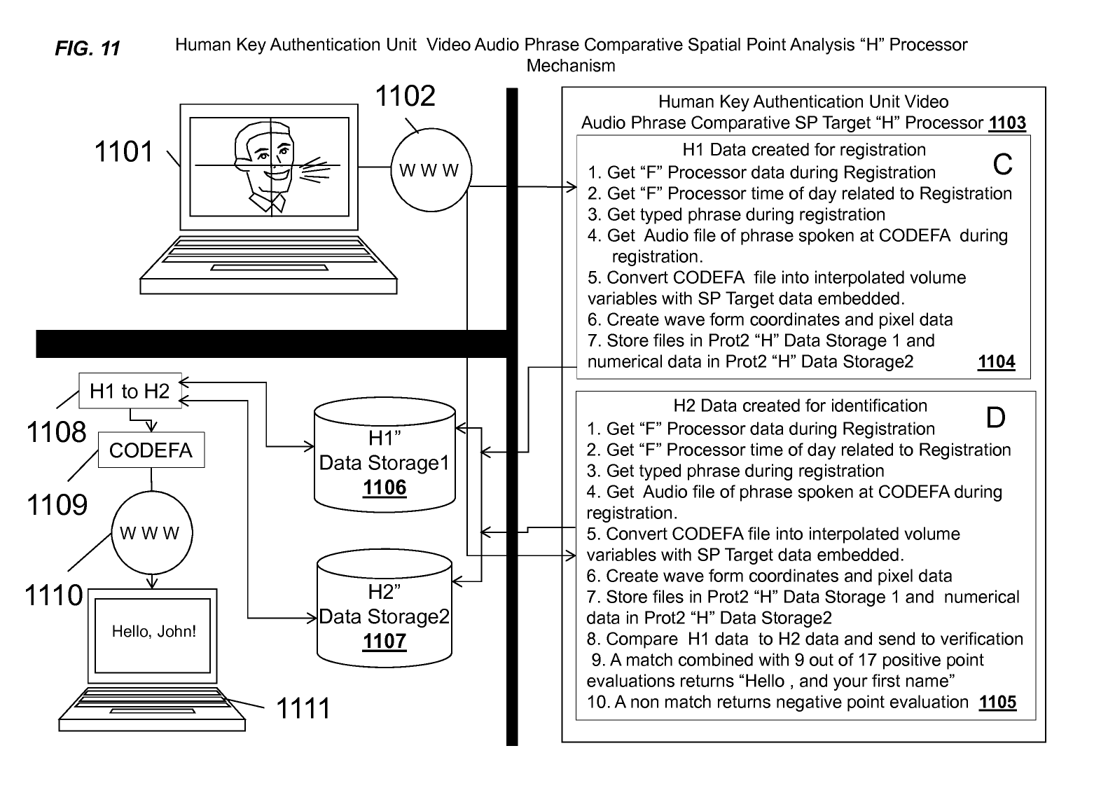

Now referring to FIG. 11, a specimen is a video recorded by a mobile device such as that disclosed in FIGS. 1a-1c and streamed to a server for sign-up or sign-in. Working from a computer or mobile device 1101 and using an Internet or world wide web (WWW) connection 1102, a user using a computer or mobile device 1101, accessing an authentication unit 1103.

The authentication unit 1103 creating data for registration 1104 by: Receiving Processor data during Registration; Receiving “Processor time of day related to Registration; Receiving typed phrase during registration; Receiving Audio file of phrase spoken at CODEFA during registration; converting CODEFA file into interpolated volume variables with SP Target data embedded; creating wave form coordinates and pixel data; and storing files in a first data storage 1106 and numerical data in a second data storage 1107.

The authentication unit 1103 also creating data for identification 1105 by: Receiving Processor data during Registration; Receiving Processor time of day related to Registration; Receiving typed phrase during registration; Receiving Audio file of phrase spoken at CODEFA during registration; converting CODEFA file into interpolated volume variables with SP Target data embedded; creating wave form coordinates and pixel data; storing files in a first data storage 1106 and numerical data in a second data storage 1107; comparing data and send to verification in step 1108; and sending to verification by CODEFA 1109; matching combined with 9 out of 17 positive point evaluations returns via an Internet or WWW connection 1110, “Hello, and your first name” on a display screen of a computer 1111, while a non match returns a negative point evaluation.

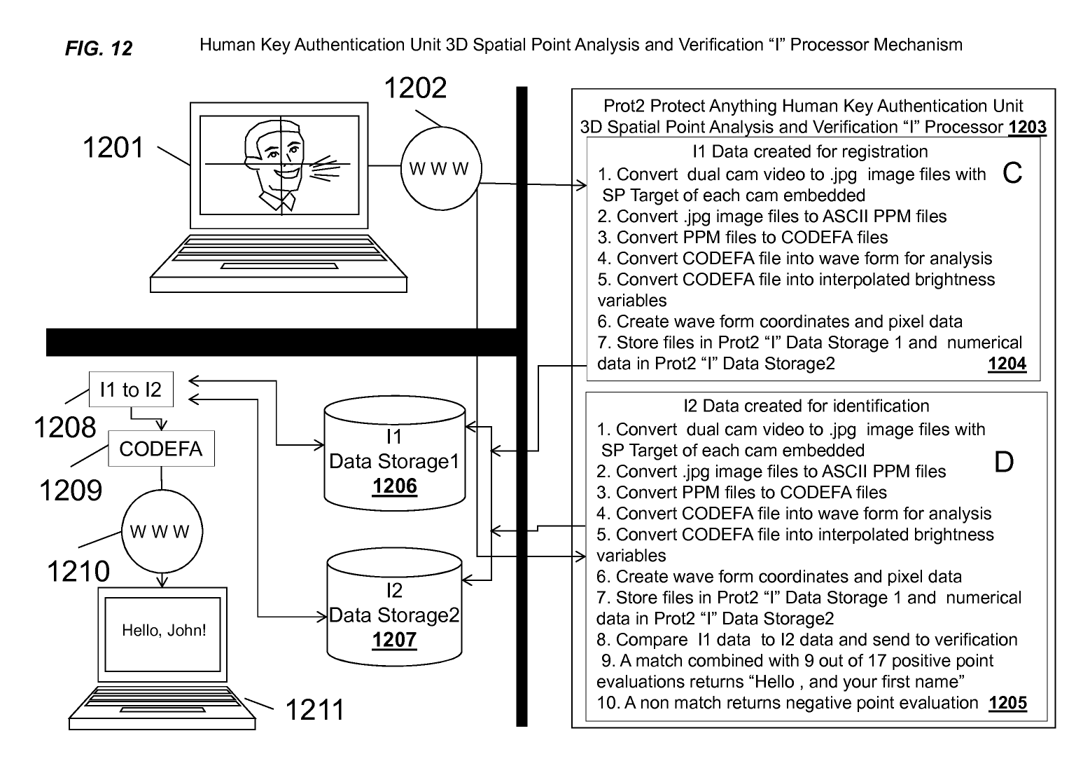

Now referring to FIG. 12, a specimen is a video recorded by a mobile device such as that disclosed in FIGS. 1a-1c and streamed to a server for sign-up or sign-in. Working from a computer or mobile device 1201 and using an Internet or world wide web (WWW) connection 1202, a user using a computer or mobile device 1201, accessing an authentication unit 1203.

The authentication unit 1203 creating data for registration 1204 by: converting dual cam video to .jpg image files with SP Target of each cam embedded; converting .jpg image files to ASCII PPM files; converting PPM files to CODEFA files; converting CODEFA file into wave form for analysis; converting CODEFA file into interpolated brightness variables; creating wave form coordinates and pixel data; storing files in a first data storage 1206 and numerical data in a second data storage 1207.

The authentication unit 1203 also creating data for identification 1205 by: converting dual cam video to .jpg image files with SP Target of each cam embedded; converting .jpg image files to ASCII PPM files; converting PPM files to CODEFA files; converting CODEFA file into wave form for analysis; converting CODEFA file into interpolated brightness variables; creating wave form coordinates and pixel data; storing files in a first data storage 1206 and numerical data in a second data storage 1207; comparing data and send to verification in step 1208; and sending to verification by CODEFA 1209; matching combined with 9 out of 17 positive point evaluations returns via an Internet or WWW connection 1210, “Hello, and your first name” on a display screen of a computer 1211, while a non match returns a negative point evaluation.

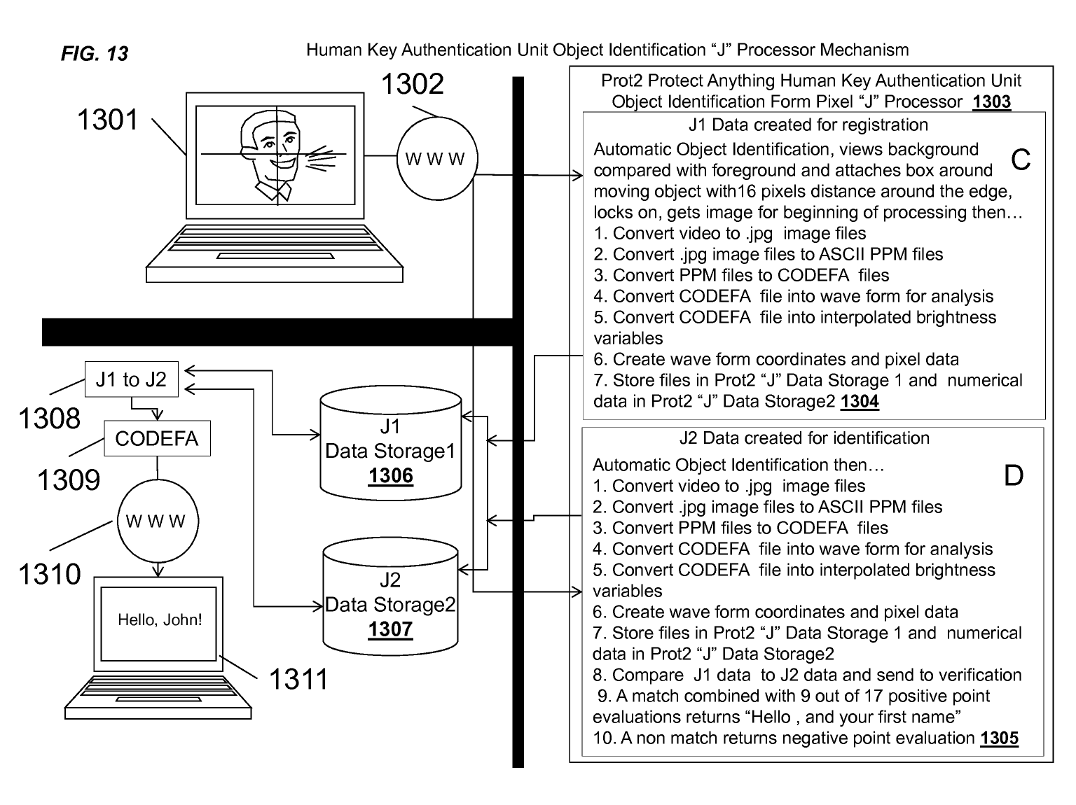

Now referring to FIG. 13, a specimen is a video recorded by a mobile device such as that disclosed in FIGS. 1a-1c and streamed to a server for sign-up or sign-in. Working from a computer or mobile device 1201 and using an Internet or world wide web (WWW) connection 1302, a user using a computer or mobile device 1301, accessing an authentication unit 1303.

The authentication unit 1303 creating data for registration 1304 Automatic Object Identification, views background compared with foreground and attaches box around moving object with 16 pixels distance around the edge, locks on, gets image for beginning of processing then: converting video to .jpg image files; converting .jpg image files to ASCII PPM files; converting PPM files to CODEFA files; converting CODEFA file into wave form for analysis; converting CODEFA file into interpolated brightness variables; creating wave form coordinates and pixel data; and storing files in a first data storage 1306 and numerical data in a second data storage 1307.

The authentication unit 1303 also creating data for identification 1305 by Automatic Object Identification then: converting video to .jpg image files; converting .jpg image files to ASCII PPM files; converting PPM files to CODEFA files; converting CODEFA file into wave form for analysis; converting CODEFA file into interpolated brightness variables; creating wave form coordinates and pixel data; and storing files in a first data storage 1306 and numerical data in a second data storage 1307; comparing data and send to verification in step 1308; and sending to verification by CODEFA 1309; matching combined with 9 out of 17 positive point evaluations returns via an Internet or WWW connection 1310, “Hello, and your first name” on a display screen of a computer 1311, while a non match returns a negative point evaluation.

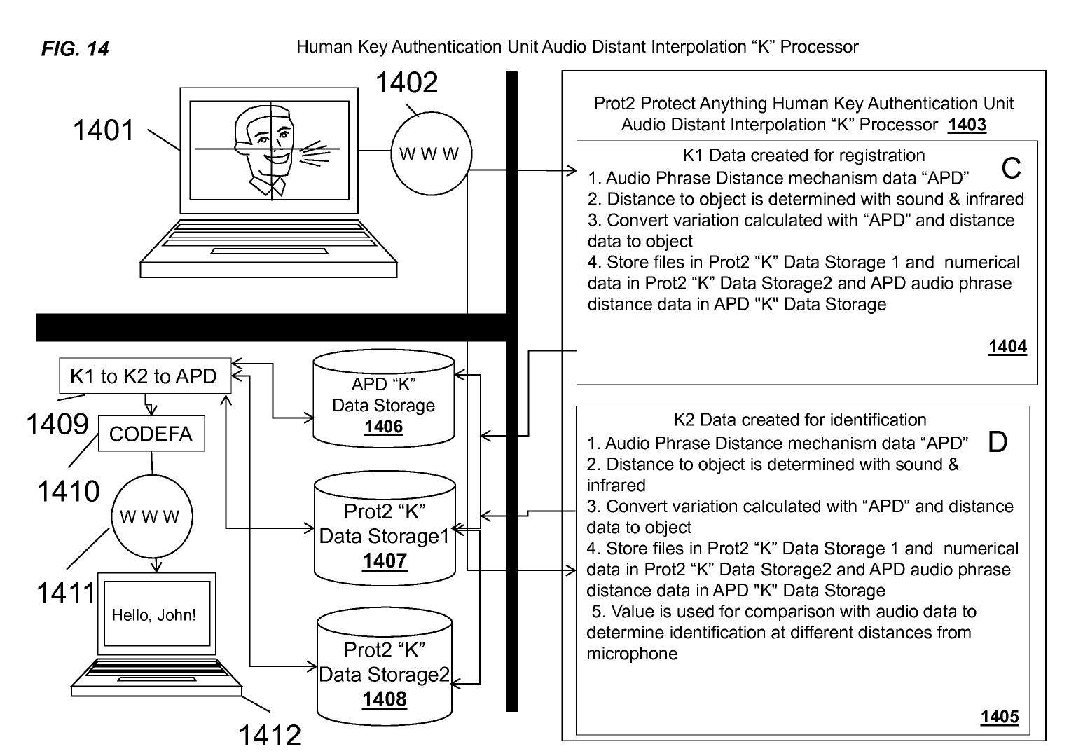

Now referring to FIG. 14, a specimen is a video recorded by a mobile device such as that disclosed in FIGS. 1a-1c and streamed to a server for sign-up or sign-in. Working from a computer or mobile device 1401 and using an Internet or world wide web (WWW) connection 1402, a user using a computer or mobile device 1401, accessing an authentication unit 1403.

The authentication unit 1403 creating data for registration 1404 by: using an Audio Phrase Distance device comprised of on the phone or device, that sending data back to the main server for evaluation and decision to determine Distance to object using sound and infrared data; converting variation calculated with “APD” and distance data to object data; storing files in a first data storage 1406, numerical data in a second data storage 1407, and audio phrase distance data in a third data storage 1408.

The authentication unit 1403 also creating data for identification 1405 by: using an Audio Phrase Distanced (ADP) device to determine Distance to object using sound and infrared data; converting variation calculated with “APD” and distance data to object data; storing files in a first data storage 1406, numerical data in a second data storage 1407, and audio phrase distance data in a third data storage 1408 and values are used for comparison with audio data to determine identification at different distances from microphone in step 1408. Matching combined with 9 out of 17 positive point evaluations returns via an Internet or WWW connection 1410, “Hello, and your first name” on a display screen of a computer 1411, while a non match returns a negative point evaluation.

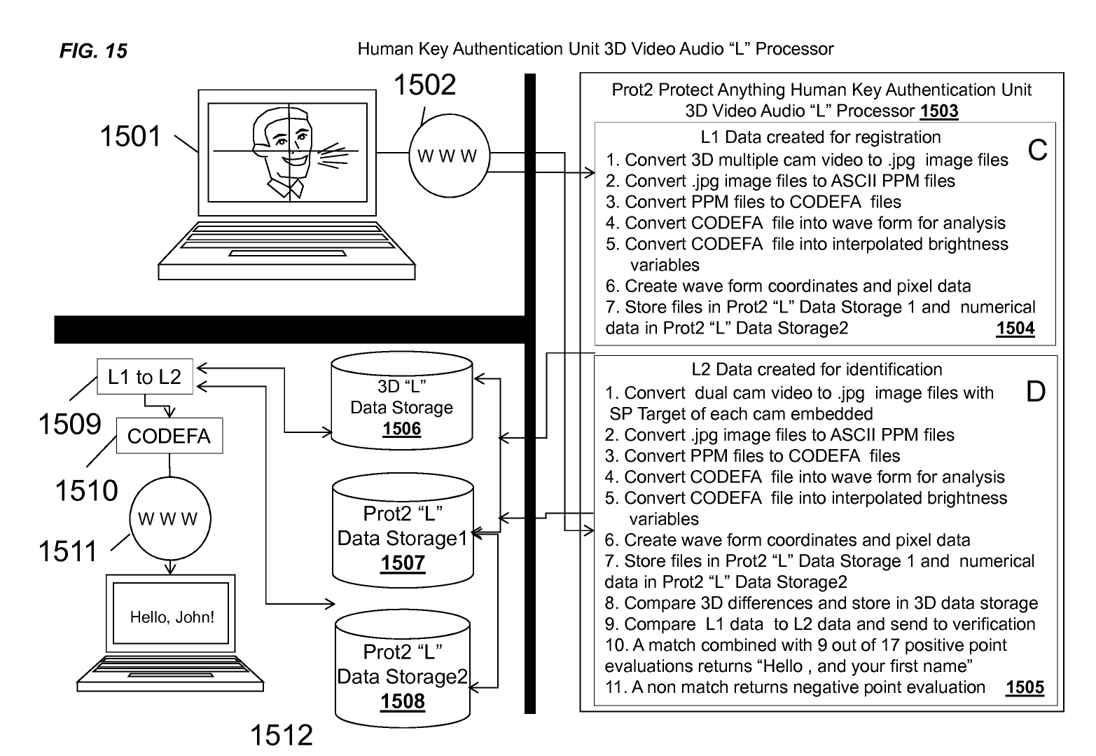

Now referring to FIG. 15, a specimen is a video recorded by a mobile device such as that disclosed in FIGS. 1a-1c and streamed to a server for sign-up or sign-in. Working from a computer or mobile device 1501 and using an Internet or world wide web (WWW) connection 1502, a user using a computer or mobile device 1501, accessing an authentication unit 1503.

The authentication unit 1503 creating data for registration 1504 by: converting 3D multiple cam video to .jpg image files; converting .jpg image files to ASCII PPM files; converting PPM files to CODEFA files; converting CODEFA file into wave form for analysis; converting CODEFA file into interpolated brightness variables; creating wave form coordinates and pixel data; storing files in a first data storage 1506 and numerical data in a second data storage 1507.

The authentication unit 1503 also creating data for identification 1505 by: converting dual cam video to .jpg image files with SP Target of each cam embedded; converting .jpg image files to ASCII PPM files; converting PPM files to CODEFA files; converting CODEFA file into wave form for analysis; converting CODEFA file into interpolated brightness variables; creating wave form coordinates and pixel data; storing files in a first data storage 1506 and numerical data in a second data storage 1507; comparing 3D differences and store in 3D data storage 1508; comparing data in a first data storage 1506 and numerical data in a second data storage 1507 in step 1509 and send to verification in step 1510; A match combined with 9 out of 17 positive point evaluations returns via an Internet or WWW connection 1510, “Hello, and your first name” on a display screen of a computer 1511, while a non match returns a negative point evaluation.

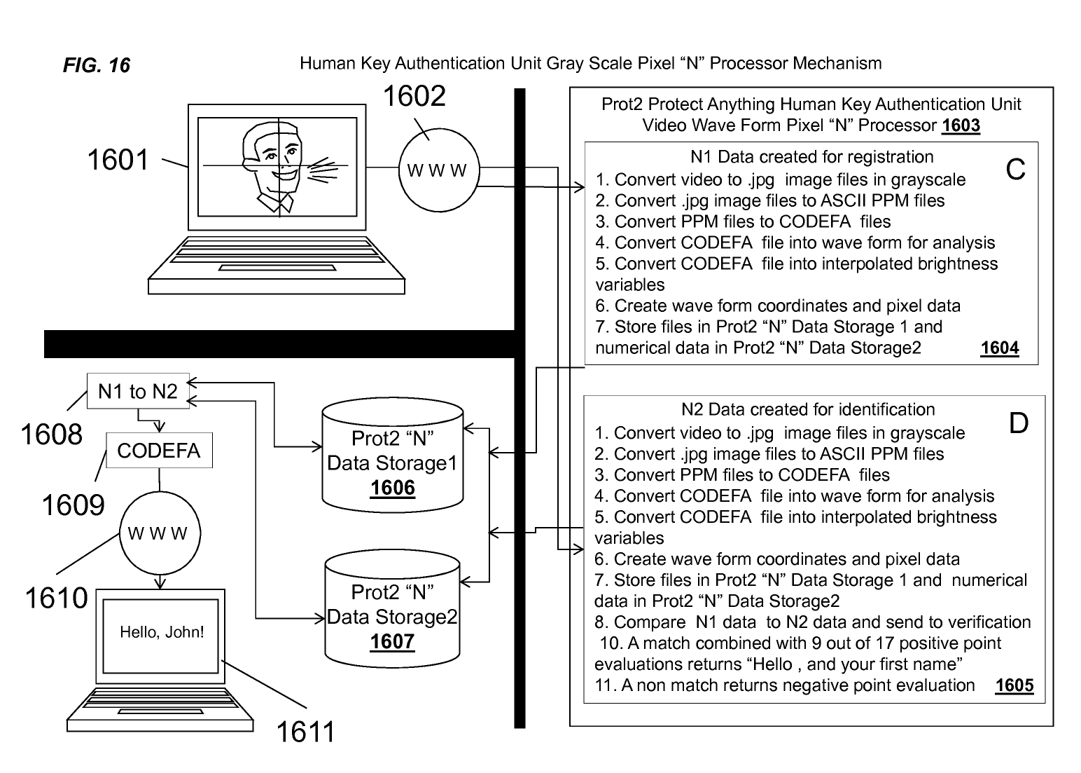

Now referring to FIG. 16, a specimen is a video recorded by a mobile device such as that disclosed in FIGS. 1a-1c and streamed to a server for sign-up or sign-in. Working from a computer or mobile device 1601 and using an Internet or world wide web (WWW) connection 1602, a user using a computer or mobile device 1601, accessing an authentication unit 1603.

The authentication unit 1603 creating data for registration 1604 by: converting video to .jpg image files in grayscale; converting .jpg image files to ASCII PPM files; converting PPM files to CODEFA files; converting CODEFA file into wave form for analysis; converting CODEFA file into interpolated brightness variables; creating wave form coordinates and pixel data; and storing files in a first data storage 1606 and numerical data in a second data storage 1607.

The authentication unit 1603 also creating data for identification 1605 by: converting video to .jpg image files in grayscale; converting .jpg image files to ASCII PPM files; converting PPM files to CODEFA files; converting CODEFA file into wave form for analysis; converting CODEFA file into interpolated brightness variables; creating wave form coordinates and pixel data; storing files in a first data storage 1606 and numerical data in a second data storage 1607; comparing data stored in the databases 1608 and send to verification in step 1609. A match combined with 9 out of 17 positive point evaluations returns via an Internet or WWW connection 1610, “Hello, and your first name” on a display screen of a computer 1611, while a non match returns a negative point evaluation.

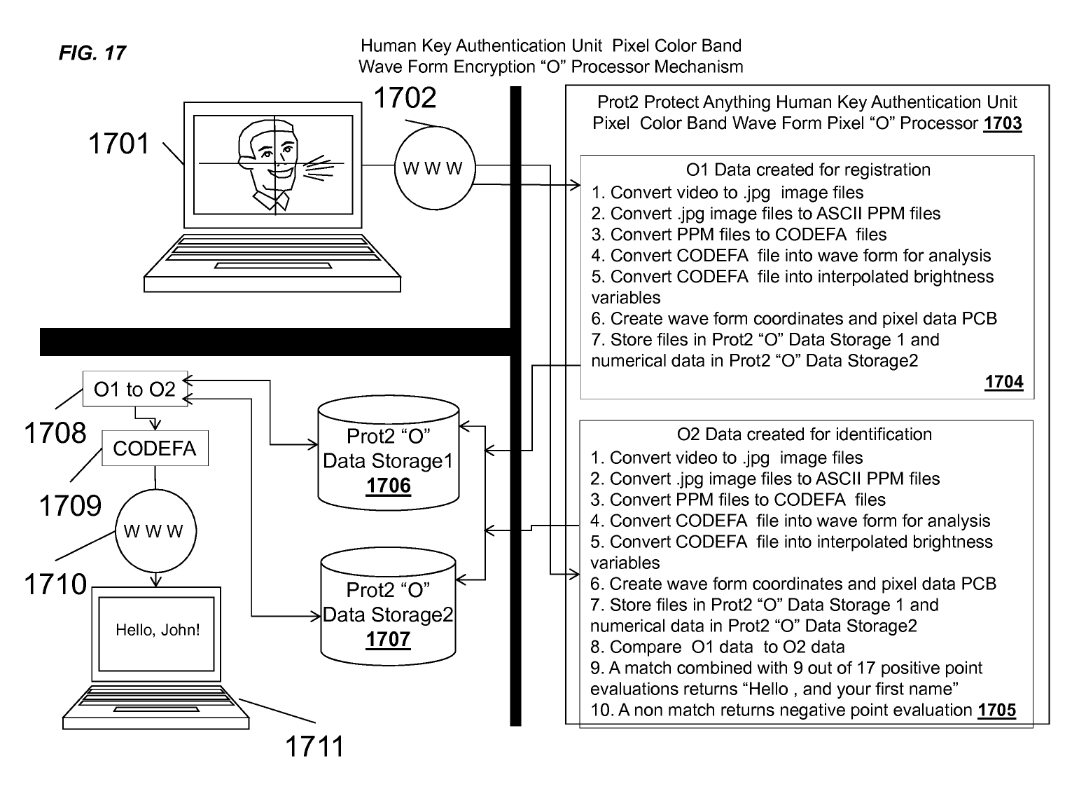

Now referring to FIG. 17, a specimen is a video recorded by a mobile device such as that disclosed in FIGS. 1a-1c and streamed to a server for sign-up or sign-in. Working from a computer or mobile device 1701 and using an Internet or world wide web (WWW) connection 1702, a user using a computer or mobile device 1701, accessing an authentication unit 1703.

The authentication unit 1703 creating data for registration 1704 by: converting video to .jpg image files; converting .jpg image files to ASCII PPM files; converting PPM files to CODEFA files; converting CODEFA file into wave form for analysis; converting CODEFA file into interpolated brightness variables; creating wave form coordinates and pixel data PCB; and storing files in a first data storage 1706 and numerical data in a second data storage 1707.

The authentication unit 1703 also creating data for identification 1705 by: converting video to .jpg image files; converting .jpg image files to ASCII PPM files; converting PPM files to CODEFA files; converting CODEFA file into wave form for analysis; converting CODEFA file into interpolated brightness variables; creating wave form coordinates and pixel data PCB; storing files in a first data storage 1706 and numerical data in a second data storage 1707; comparing data stored in the databases in step 1708 using CODEFA 1709. A match combined with 9 out of 17 positive point evaluations returns via an Internet or WWW connection 1710, “Hello, and your first name” on a display screen of a computer 1711, while a non match returns a negative point evaluation.

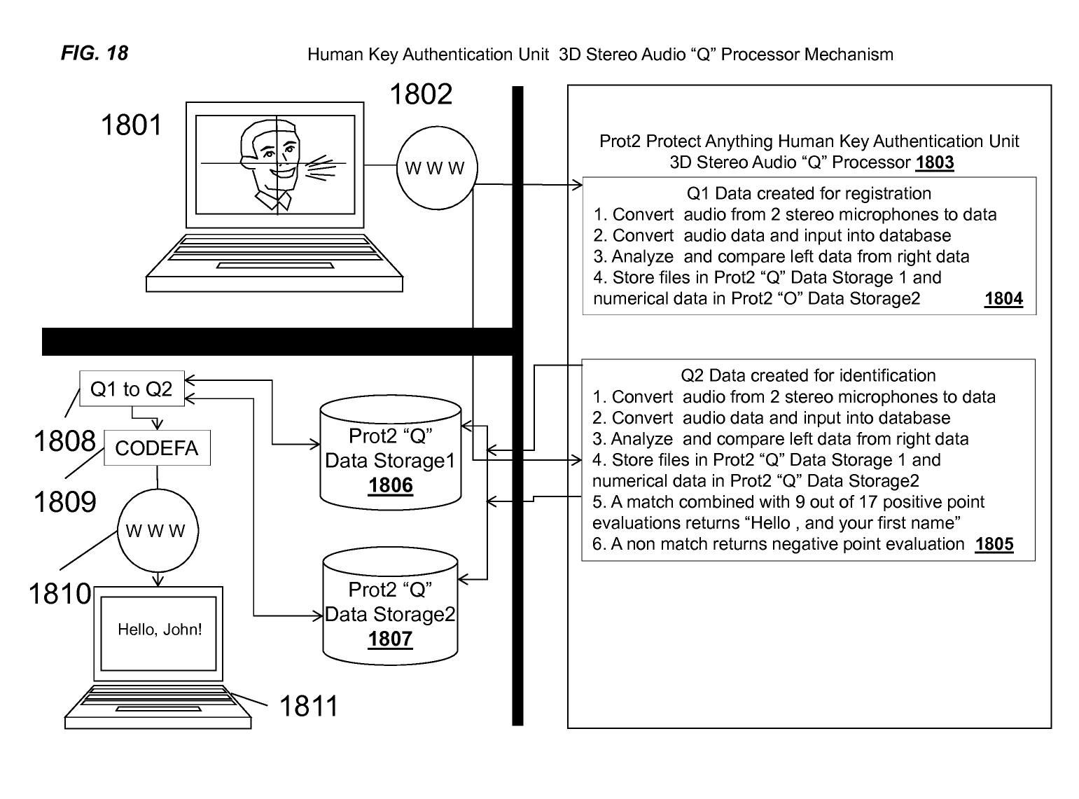

Now referring to FIG. 18, a specimen is a video recorded by a mobile device such as that disclosed in FIGS. 1a-1c and streamed to a server for sign-up or sign-in. Working from a computer or mobile device 1801 and using an Internet or world wide web (WWW) connection 1802, a user using a computer or mobile device 1801, accessing an authentication unit 1803.

The authentication unit 1803 creating data for registration 1804 by: converting audio from 2 stereo microphones to data; converting audio data and input into database; Analyze and compare left data from right data; and storing files in a first data storage 1806 and numerical data in a second data storage 1807.

The authentication unit 1803 creating data for identification 1805 by: converting audio from two stereo microphones to data; converting audio data and input into databases; analyzing and comparing left date from right data; storing files in a first data storage 1806 and numerical data in a second data storage 1807. comparing data stored in the databases in step 1808 using CODEFA 1809. A match combined with 9 out of 17 positive point evaluations returns via an Internet or WWW connection 1810, “Hello, and your first name” on a display screen of a computer 1811, while a non match returns a negative point evaluation.

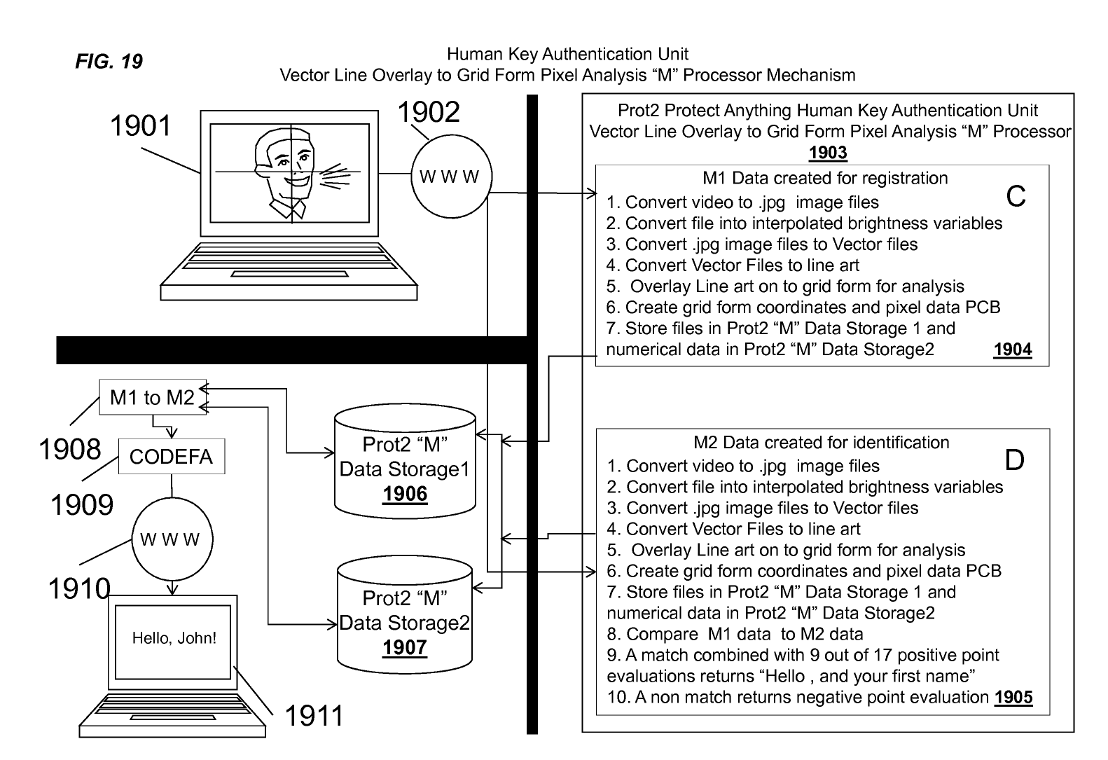

Now referring to FIG. 19, a specimen is a video recorded by a mobile device such as that disclosed in FIGS. 1a-1c and streamed to a server for sign-up or sign-in. Working from a computer or mobile device 1901 and using an Internet or world wide web (WWW) connection 1902, a user using a computer or mobile device 1901, accessing an authentication unit 1903.

The authentication unit 1903 creating data for registration 1904 by: converting video to .jpg image files; converting file into interpolated brightness variables; converting .jpg image files to Vector files; converting Vector Files to line art; overlaying Line art on to grid form for analysis; creating grid form coordinates and pixel data PCB; and storing files in a first data storage 1906 and numerical data in a second data storage 1907.

The authentication unit 1903 creating data for identification 1905 by: converting video to .jpg image files; converting file into interpolated brightness variables; converting .jpg image files to Vector files; converting Vector Files to line art; overlaying Line art on to grid form for analysis; creating grid form coordinates and pixel data PCB; storing files in a first data storage 1906 and numerical data in a second data storage 1907; comparing data in step 1908 using CODEFA 1909. A match combined with 9 out of 17 positive point evaluations returns via an Internet or WWW connection 1910, “Hello, and your first name” on a display screen of a computer 1911, while a non match returns a negative point evaluation.

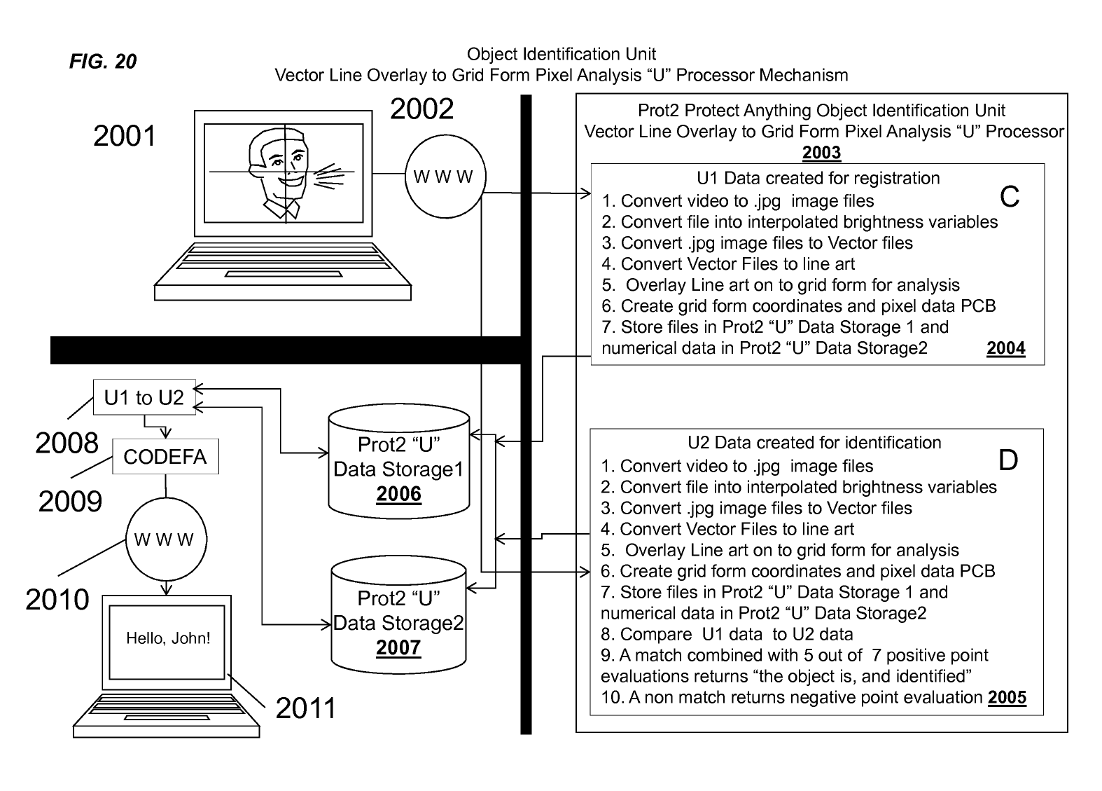

Now referring to FIG. 20, a specimen is a video recorded by a mobile device such as that disclosed in FIGS. 1a-1c and streamed to a server for sign-up or sign-in. Working from a computer or mobile device 2001 and using an Internet or world wide web (WWW) connection 2002, a user using a computer or mobile device 2001, accessing an authentication unit 2003.

The authentication unit 2003 creating data for registration 2004 by: converting video to .jpg image files; converting file into interpolated brightness variables; converting .jpg image files to Vector files; converting Vector Files to line art; overlaying Line art on to grid form for analysis; creating grid form coordinates and pixel data PCB; and storing files in a first data storage 2006 and numerical data in a second data storage 2007.

The authentication unit 2003 creating data for identification 2005 by: converting video to .jpg image files; converting file into interpolated brightness variables; converting .jpg image files to Vector files; converting Vector Files to line art; overlaying Line art on to grid form for analysis; creating grid form coordinates and pixel data PCB; storing files in a first data storage 2006 and numerical data in a second data storage 2007; comparing data stored in the databases in step 2008 using CODEFA 2009. A match combined with 9 out of 17 positive point evaluations returns via an Internet or WWW connection 2010, “Hello, and your first name” on a display screen of a computer 2011, while a non match returns a negative point evaluation.

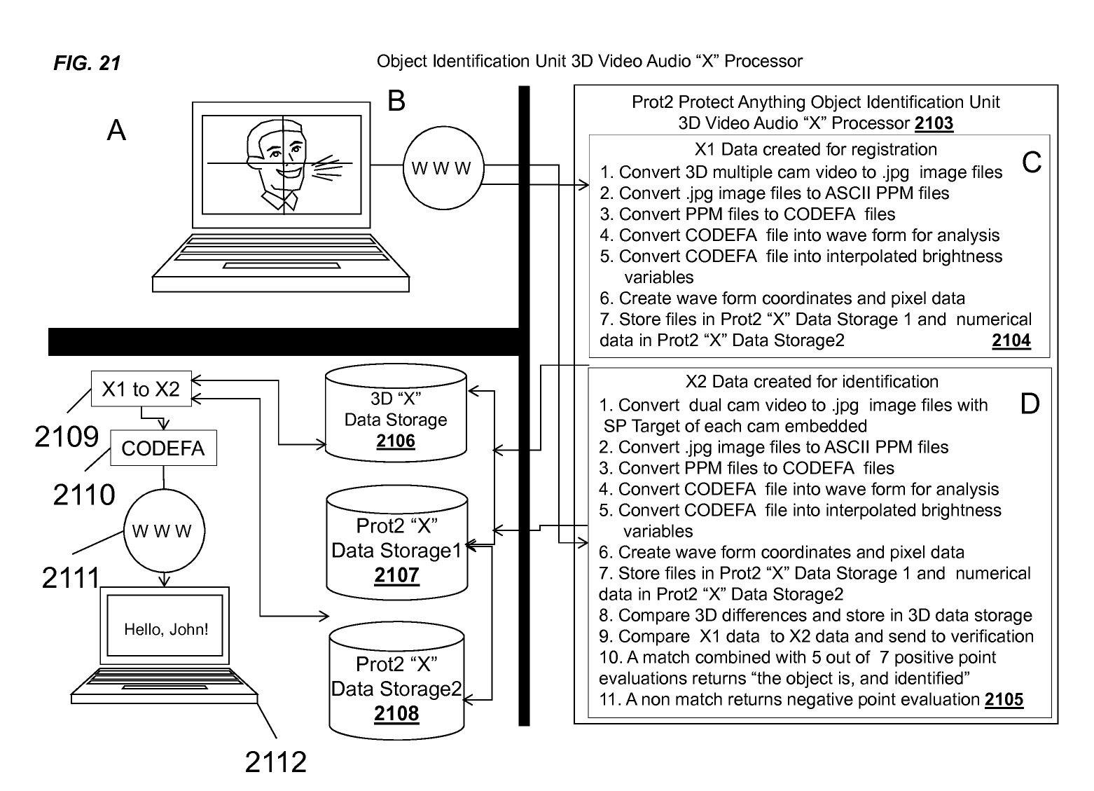

Now referring to FIG. 21, a specimen is a video recorded by a mobile device such as that disclosed in FIGS. 1a-1c and streamed to a server for sign-up or sign-in. Working from a computer or mobile device 2101 and using an Internet or world wide web (WWW) connection 2102, a user using a computer or mobile device 2101, accessing an authentication unit 2103.

The authentication unit 2103 creating data for registration 2104 by: converting 3D multiple cam video to .jpg image files; converting .jpg image files to ASCII PPM files; converting PPM files to CODEFA files; converting CODEFA file into wave form for analysis; converting CODEFA file into interpolated brightness variables; creating wave form coordinates and pixel data; and storing files in a first data storage 2106 and numerical data in a second data storage 2107.

The authentication unit 2103 creating data for identification 2105 by: converting dual cam video to .jpg image files with SP Target of each cam embedded; converting .jpg image files to ASCII PPM files; converting PPM files to CODEFA files; converting CODEFA file into wave form for analysis; converting CODEFA file into interpolated brightness variables; creating wave form coordinates and pixel data; storing files in a first data storage 2106 and numerical data in a second data storage 2107; comparing 3D differences and store in 3D data storage 2108; comparing data and send to verification in step 2109 using CODEFA. A match combined with 9 out of 17 positive point evaluations returns via an Internet or WWW connection 2110, “Hello, and your first name” on a display screen of a computer 2111, while a non match returns a negative point evaluation.

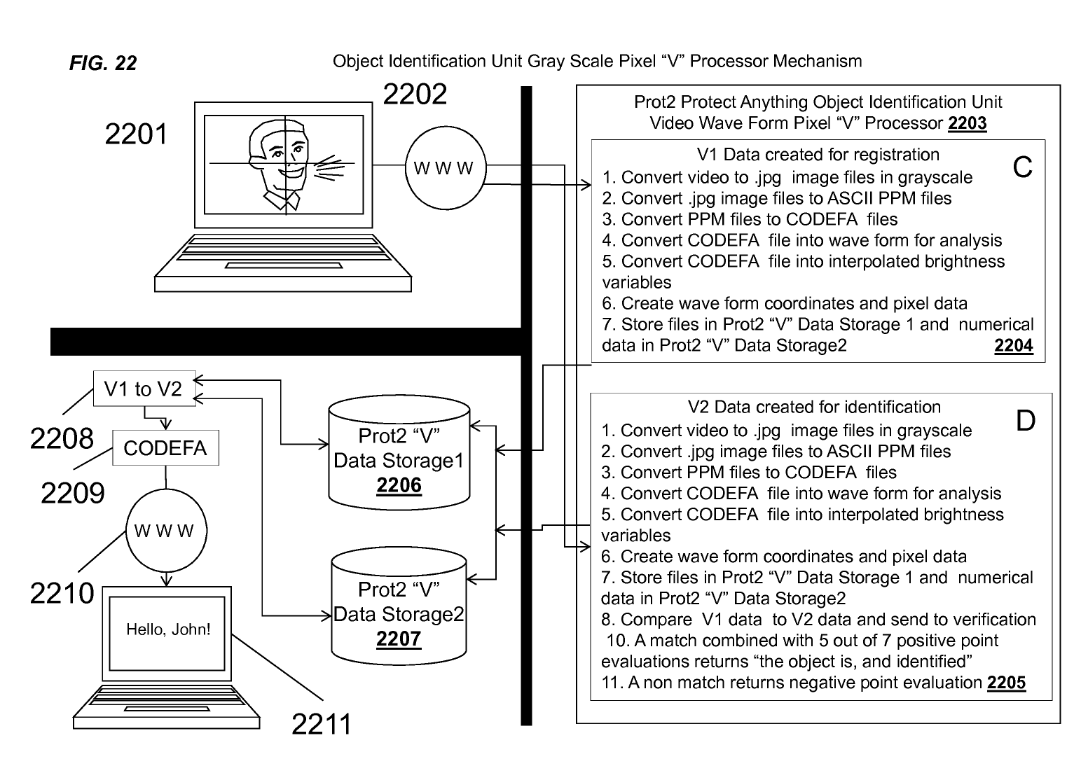

Now referring to FIG. 22, a specimen is a video recorded by a mobile device such as that disclosed in FIGS. 1a-1c and streamed to a server for sign-up or sign-in. Working from a computer or mobile device 2201 and using an Internet or world wide web (WWW) connection 2202, a user using a computer or mobile device 2201, accessing an authentication unit 2203.

The authentication unit 2203 creating data for registration 2204 by: converting video to .jpg image files in grayscale; converting .jpg image files to ASCII PPM files; converting PPM files to CODEFA files; converting CODEFA file into wave form for analysis; converting CODEFA file into interpolated brightness variables; creating wave form coordinates and pixel data; storing files in a first data storage 2206 and numerical data in a second data storage 2207.

The authentication unit 2203 creating data for identification 2205 by: converting video to .jpg image files in grayscale; converting .jpg image files to ASCII PPM files; converting PPM files to CODEFA files; converting CODEFA file into wave form for analysis; converting CODEFA file into interpolated brightness variables; creating wave form coordinates and pixel data; storing files in a first data storage 2206 and numerical data in a second data storage 2207; comparing V1 data to V2 data in step 2208 and send to verification using CODEFA 2209. A match combined with 9 out of 17 positive point evaluations returns via an Internet or WWW connection 2110, “Hello, and your first name” on a display screen of a computer 2111, while a non match returns a negative point evaluation.

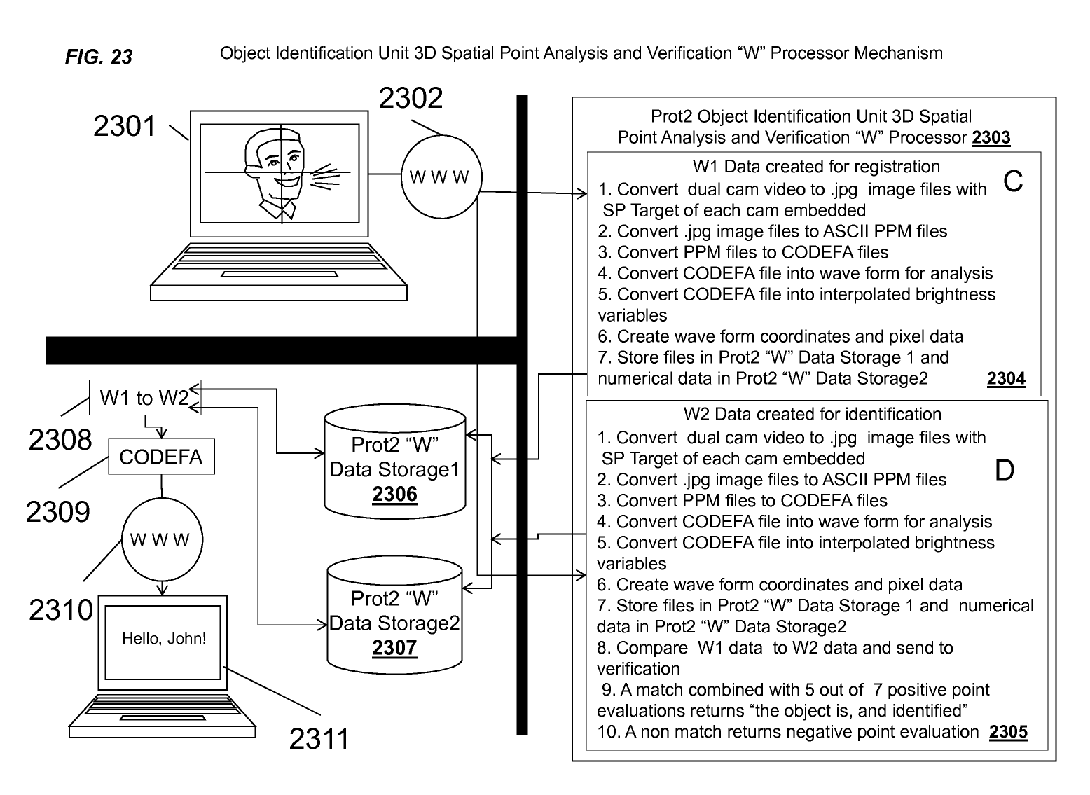

Now referring to FIG. 23, a specimen is a video recorded by a mobile device such as that disclosed in FIGS. 1a-1c and streamed to a server for sign-up or sign-in. Working from a computer or mobile device 2301 and using an Internet or world wide web (WWW) connection 2302, a user using a computer or mobile device 2301, accessing an authentication unit 2303.

The authentication unit 2303 creating data for registration 2304 by: converting dual cam video to .jpg image files with SP Target of each cam embedded; converting .jpg image files to ASCII PPM files; converting PPM files to CODEFA files; converting CODEFA file into wave form for analysis; converting CODEFA file into interpolated brightness variables; creating wave form coordinates and pixel data; storing files in a first data storage 2306 and numerical data in a second data storage 2307.

The authentication unit 2303 creating data for identification 2305 by: converting dual cam video to .jpg image files with SP Target of each cam embedded; converting .jpg image files to ASCII PPM files; converting PPM files to CODEFA files; converting CODEFA file into wave form for analysis; converting CODEFA file into interpolated brightness variables; creating wave form coordinates and pixel data; storing files in a first data storage 2306 and numerical data in a second data storage 2307; comparing data in step 2308 and send to verification using CODEFA in step 2309. A match combined with 9 out of 17 positive point evaluations returns via an Internet or WWW connection 2310, “Hello, and your first name” on a display screen of a computer 2311, while a non match returns a negative point evaluation.

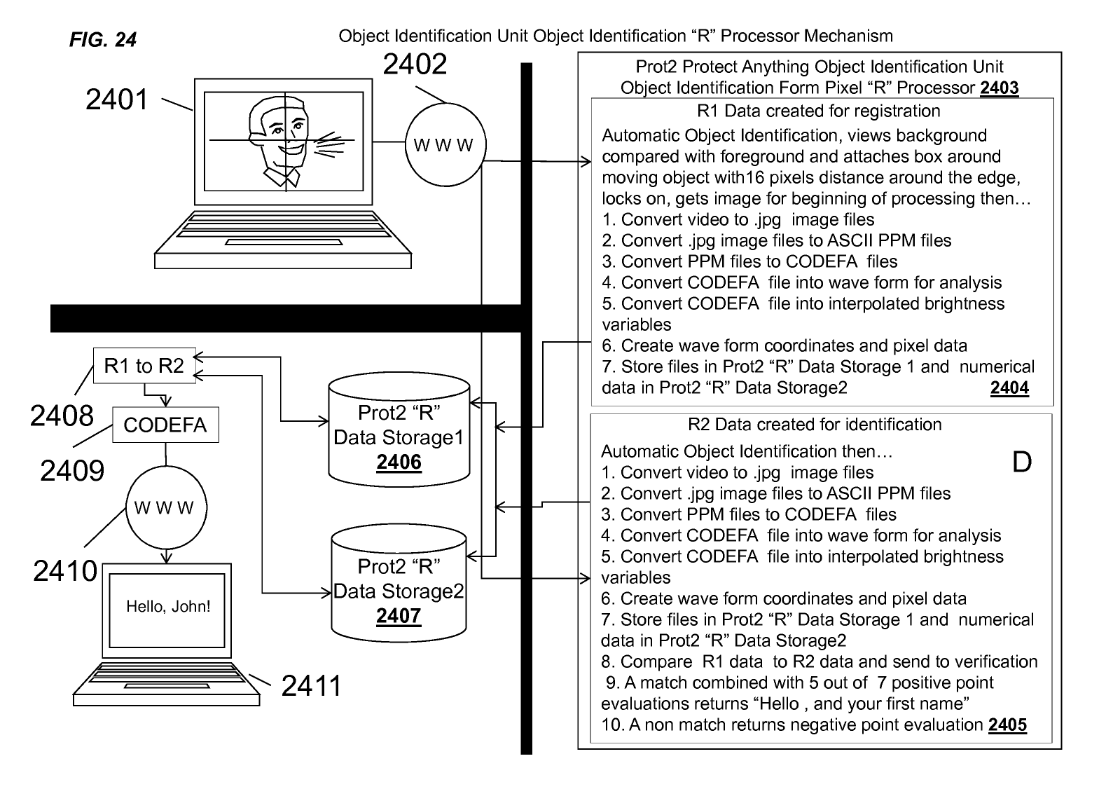

Now referring to FIG. 24, a specimen is a video recorded by a mobile device such as that disclosed in FIGS. 1a-1c and streamed to a server for sign-up or sign-in. Working from a computer or mobile device 2401 and using an Internet or world wide web (WWW) connection 2402, a user using a computer or mobile device 2401, accessing an authentication unit 2403.

The authentication unit 2403 creating data for registration 2404 by Automatic Object Identification, views background compared with foreground and attaches box around moving object with 16 pixels distance around the edge, locks on, gets image for beginning of processing then: converting video to .jpg image files; converting .jpg image files to ASCII PPM files; converting PPM files to CODEFA files; converting CODEFA file into wave form for analysis; converting CODEFA file into interpolated brightness variables; creating wave form coordinates and pixel data; and storing files in a first data storage 2406 and numerical data in a second data storage 2407.

The authentication unit 2403 creating data for identification 2405 by Automatic Object Identification then: converting video to .jpg image files; converting .jpg image files to ASCII PPM files; converting PPM files to CODEFA files; converting CODEFA file into wave form for analysis; converting CODEFA file into interpolated brightness variables; creating wave form coordinates and pixel data; storing files in a first data storage 2406 and numerical data in a second data storage 2407; comparing data stored in the databases in step 2408 and send to verification via CODEFA in step 2409. A match combined with 9 out of 17 positive point evaluations returns via an Internet or WWW connection 2410, “Hello, and your first name” on a display screen of a computer 2411, while a non match returns a negative point evaluation.

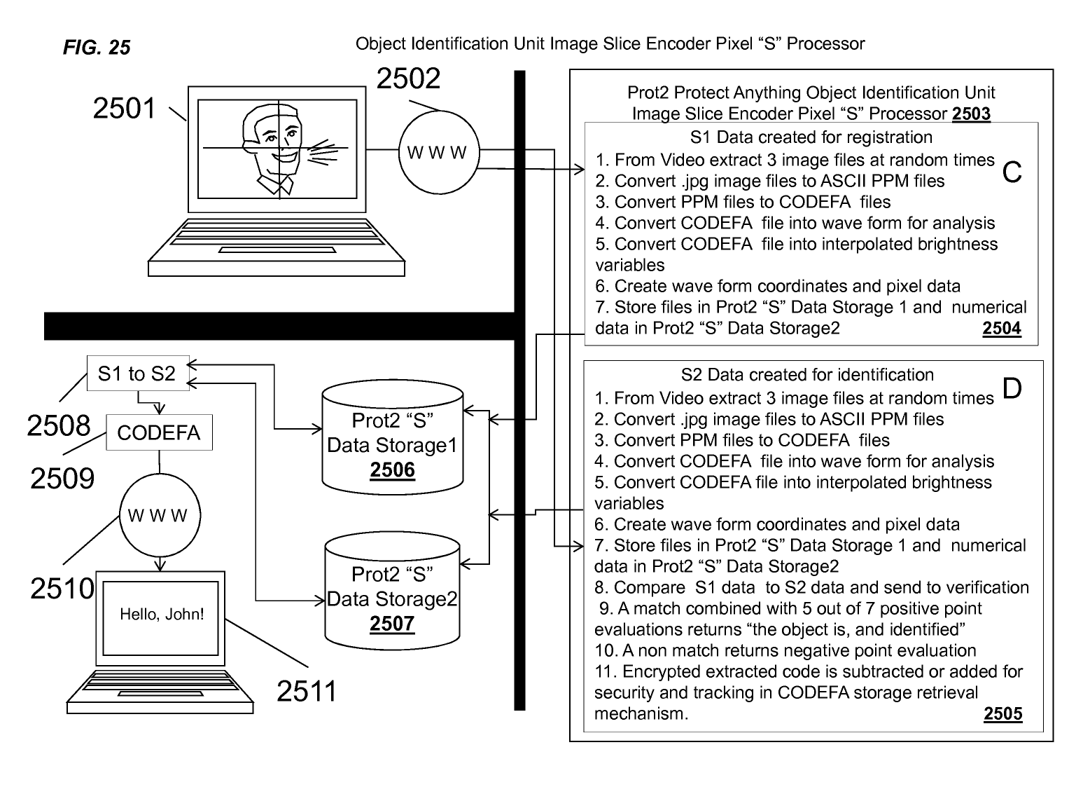

Now referring to FIG. 25, a specimen is a video recorded by a mobile device such as that disclosed in FIGS. 1a-1c and streamed to a server for sign-up or sign-in. Working from a computer or mobile device 2501 and using an Internet or world wide web (WWW) connection 2502, a user using a computer or mobile device 2501, accessing an authentication unit 2503.

The authentication unit 2503 creating data for registration 2504 by: extracting from video 3 image files at random times; converting .jpg image files to ASCII PPM files; converting PPM files to CODEFA files; converting CODEFA file into wave form for analysis; converting CODEFA file into interpolated brightness variables; creating wave form coordinates and pixel data; and storing files in a first data storage 2506 and numerical data in a second data storage 2507.

The authentication unit 2403 creating data for identification 2505 by: extracting from video 3 image files at random times; converting .jpg image files to ASCII PPM files; converting PPM files to CODEFA files; converting CODEFA file into wave form for analysis; converting CODEFA file into interpolated brightness variables; creating wave form coordinates and pixel data; storing files in a first data storage 2506 and numerical data in a second data storage 2507; comparing data stored in the databases in step 2508 and send to verification using CODEFA in step 2509. A match combined with 9 out of 17 positive point evaluations returns via an Internet or WWW connection 2510, “Hello, and your first name” on a display screen of a computer 2511, while a non match returns a negative point evaluation.

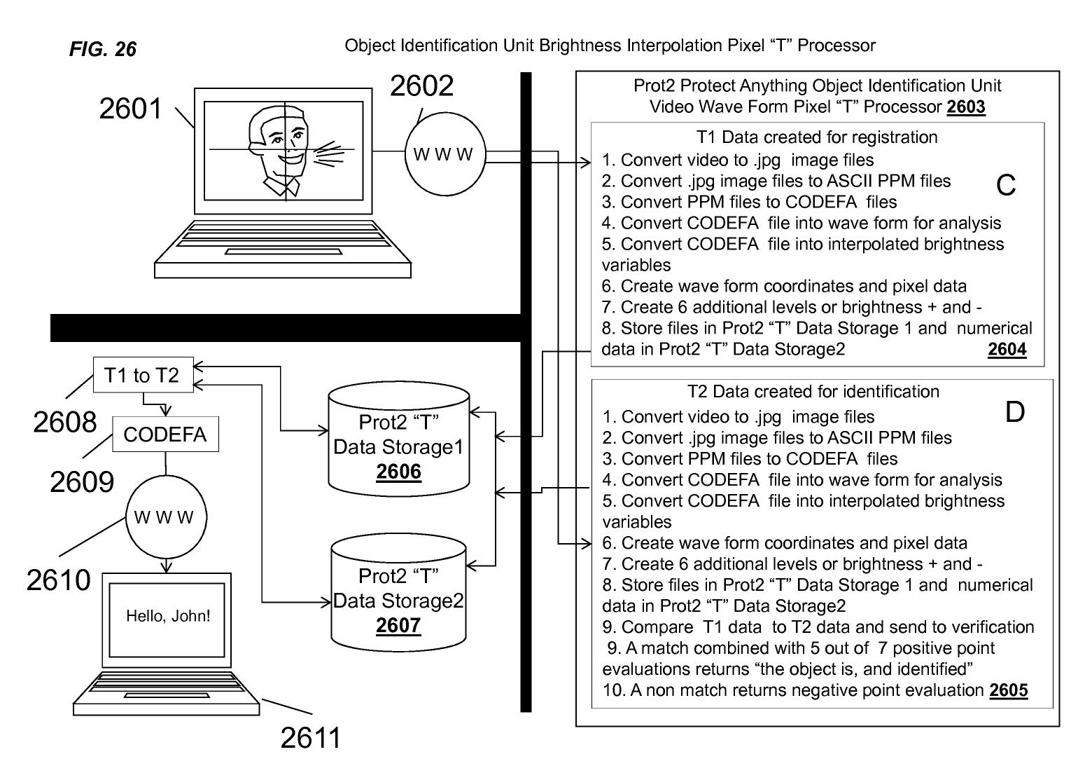

Now referring to FIG. 26, a specimen is a video recorded by a mobile device such as that disclosed in FIGS. 1a-1c and streamed to a server for sign-up or sign-in. Working from a computer or mobile device 260a and using an Internet or world wide web (WWW) connection 260s, a user using a computer or mobile device 260a, accessing an authentication unit 2603.

The authentication unit 2603 creating data for registration 2604 by: converting video to .jpg image files; converting .jpg image files to ASCII PPM files; converting PPM files to CODEFA files; converting CODEFA file into wave form for analysis; converting CODEFA file into interpolated brightness variables; creating wave form coordinates and pixel data; creating 6 additional levels or brightness + and −; storing files in a first data storage 2606 and numerical data in a second data storage 2607.

The authentication unit 2603 creating data for identification 2605 by: converting video to .jpg image files; converting .jpg image files to ASCII PPM files; converting PPM files to CODEFA files; converting CODEFA file into wave form for analysis; converting CODEFA file into interpolated brightness variables; creating wave form coordinates and pixel data; creating 6 additional levels or brightness + and −; storing files in a first data storage 2606 and numerical data in a second data storage 2607; comparing T1 data to T2 data in step 2608 and sending it to verification in step 2609. A match combined with 9 out of 17 positive point evaluations returns via an Internet or WWW connection 2610, “Hello, and your first name” on a display screen of a computer 2611, while a non match returns a negative point evaluation.

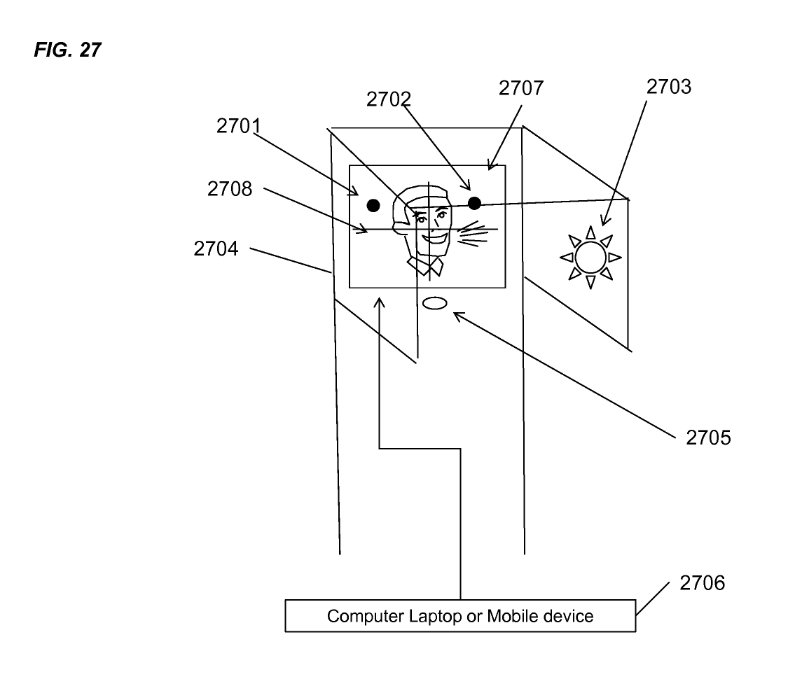

No referring to FIG. 27, a checkout or voting booth 2704 is illustrated as one embodiment of the present invention used in combination with other electronic systems. In this embodiment, a user enters the privacy booth 2704 for video and audio verification and identification. The privacy booth 2704 is a pay station where after your items are scanned, and while they are bagged up, a user walks over to the pay station and the light 22703 is red, after you are identified and you pay the light 2703 turns green and you can remove your purchases from the store. The privacy booth 2704 is comprised of a left cam 2701 and a right cam 2702, and combination speaker and microphone 2705, display screen 2707, and crosshairs 2708 for image acquisition similar to the smart phone embodiment of FIG. 1. The privacy booth 2000 is connected to a computer, laptop, or other mobile device for interacting with the system servers and computer machines for identification confirmation 2706.

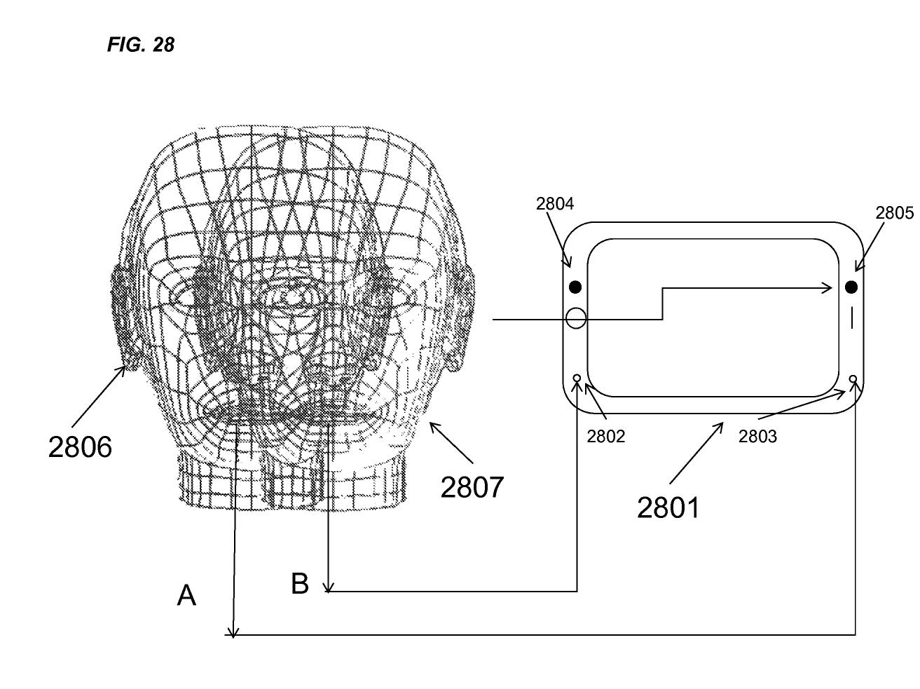

Now referring to FIG. 28, the mobile device 2801 with a 3D left cam 2804, 3D right cam 2805, 3D left audio input 2802, and 3D right input 2803 is shown. The 3D left cam 2804 takes a first image of a face 2806 centered on line A, while the 3D right cam 2805 takes a second image of a face 2807 centered on line B for comparison in the system and identification of the user. The left audio input 2802 records audio emanating from the left side of a user as shown by line A and the right audio input 2803 records audio emanating from the right side of a user as shown by line B for comparison and identification of the user.

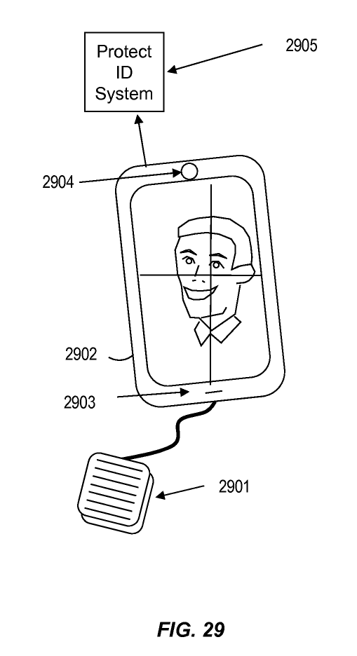

Now referring to FIG. 29, a saliva sensor 2901 and identification apparatus is shown. To verify a log in via the machine, here a smart phone 2902, the saliva sensor 2901 is connected to the smart phone 2902. Voice encryption first identifies all individuals and groups of individuals by collecting voice information through the microphone 2903 and comparing it to a known voice profile of the user in the protection system 2905. Additionally, the smart phone 2902 can use the camera 2904 to capture an image of the user and comparing the image of the user with an image in the protection system 2905. Next the DNA saliva sensor 2901 instantly can encrypt and attach a human key ID to DNA information. Instantaneous blood tests can be matched to any identity.

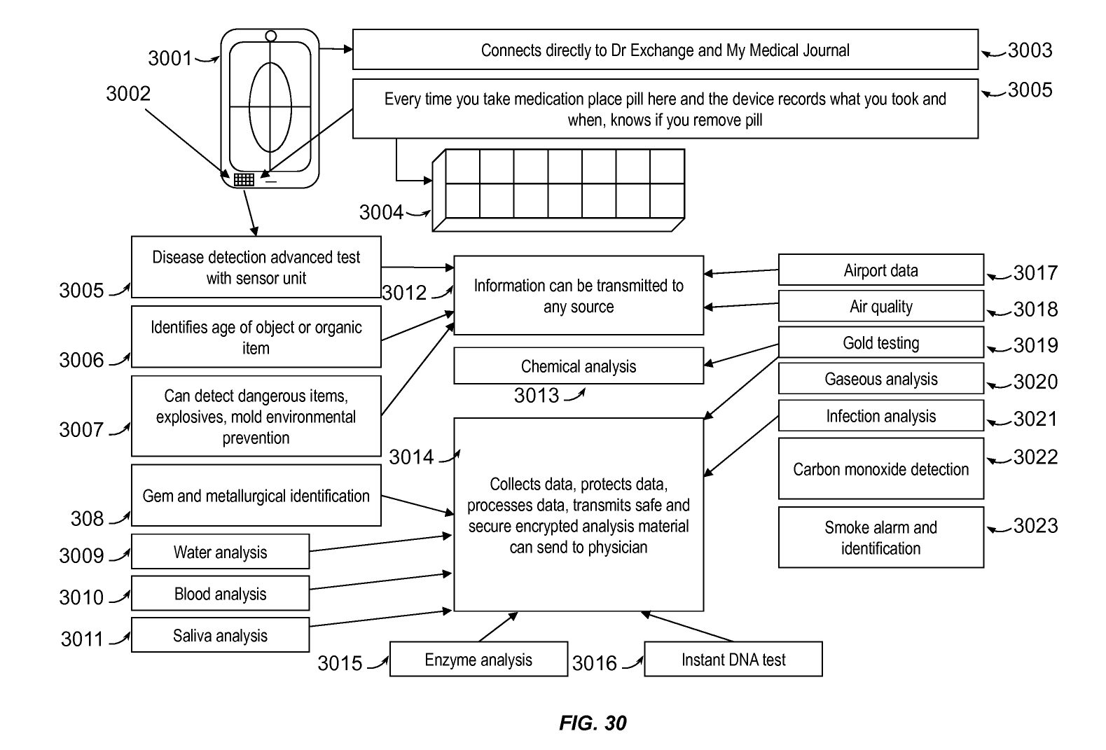

FIG. 30 illustrates a taste sensor for identification of any organic or non-organic item. A smart phone or other machine 3001 contains a human key ID. The smart phone or other machine 3001 is provided with a sensor 3002 that can detect touch or sonically detect smell or taste. Continuing with the medical/pharmaceutical example, the smart phone or other machine 3001 connects direct to a user's medical journal and dr. exchange 3003 and a pill box 3004 with a wireless connection to the smart phone or other machine 3001. Every time a user takes medication, they place the pill on the sensor 3002 and the smart phone or other machine 3001 records what they took and when, and knows if the user removed pill from the pill box 3004.

The a sensor 3002 can provide disease detection and advanced tests 3005 by identifying the age of the object 3006, detecting dangerous items 3007, which can be sent to any source 3012. Additionally, the sensor providing metallurgical identification 3008, water analysis 3009, blood analysis 3010, and saliva analysis 3011 can collect and process the data and send it to a physician for review 3014, enzyme analysis 3015, or a DNA test 3016.

Information can be transmitted to any source 3012 including, but not limited to, airport data 3017, air quality 3018, gold testing 3019 from chemical analysis 3012, gaseous analysis 3020, infection analysis 3021, carbon monoxide detection 3022, and smoke alarm detection and identification 3023.

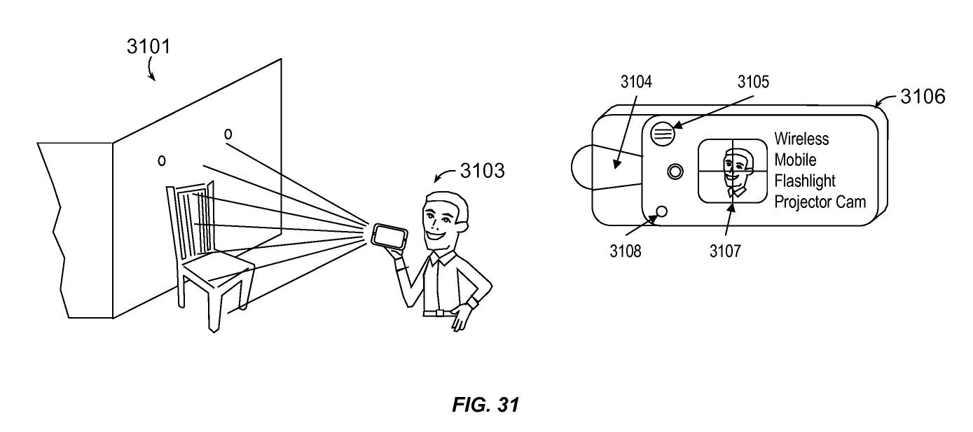

FIG. 31 illustrates the spatial point delivery to a hand held flashlight projection system connected to with a wireless human key identification. In this embodiment, a machine, such as a smart phone 3106, is comprises of a speaker 3105, microphone 3108, LED display 3107, and video projector 3104. A person 3103 directs the smart phone 3101 at a wall or other flat space 3101 and can project an image in that location. In this example, a chair is being projected into the space in front of the wall 3101. This would allow a user to try out three-dimensional furniture in their home before they buy, or art on a wall in their home.

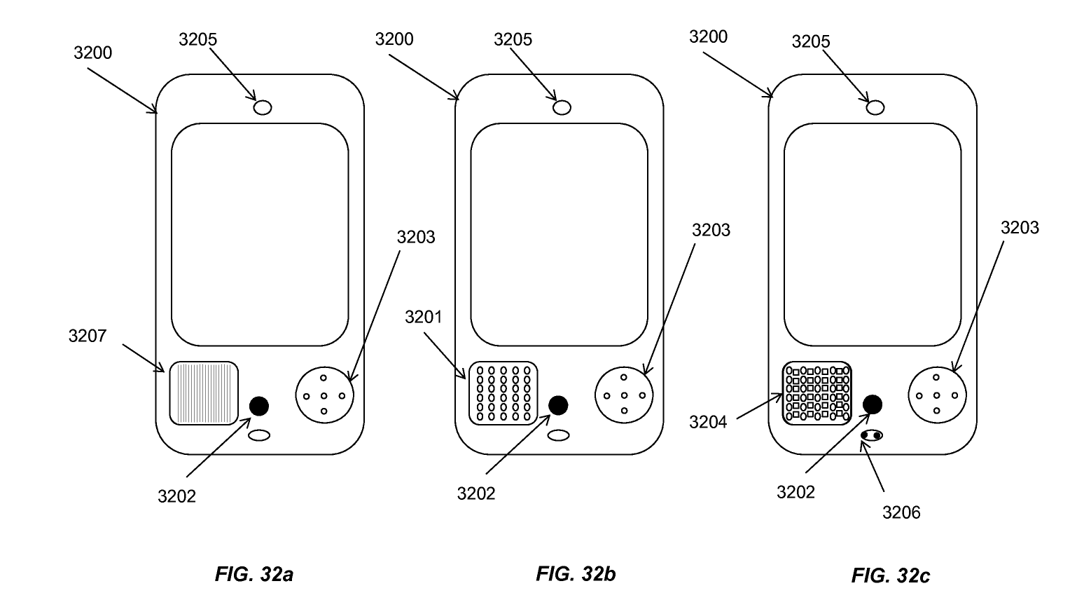

Now referring to FIGS. 32a-32c, a mobile device 3200, such as a smartphone, may be used in combination with a touch sensor 3201 with sliding cover 3207, heat sensor 3202, smell sensor 3203, and taste sensor 3204. The smell sensors 3203 records input and stores it in a database. The taste sensor 3204 can detect and identify chemicals and virusing by comparing the taste input with those known in a database. The camera 3205 can use visual input to store images in a database while a microphone 3206 can store recorded audio in a database.

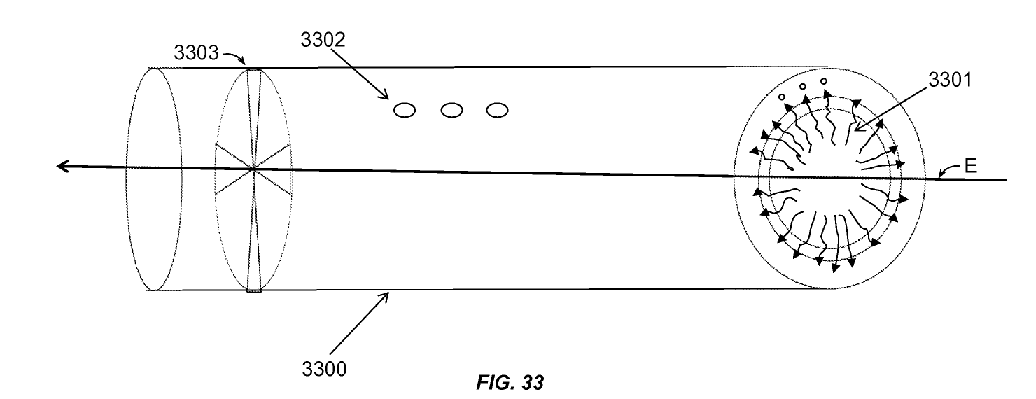

Now referring to FIG. 33, the smell sensor 3300 is further disclosed. The smell sensor 3300 is a mechanical cilia sensor of cylindrical shape with opening at one end 3303 that captures molecules on wet cilia 3301 located at the opposing end of the cylinder and by amount of majority molecules identifies utilizing stored data in the database consisting of known smells programmed with the smell sensor to make an identification. Molecules attach to the wet cilia 3301 then evaporate after analysis so new molecules can attached to the wet cilia 3301 to be analyzed. Side airports 3302 allow airflow for sampling. The system eliminates the majority of the molecules senses form its cache every 1-5 minutes for next processing.

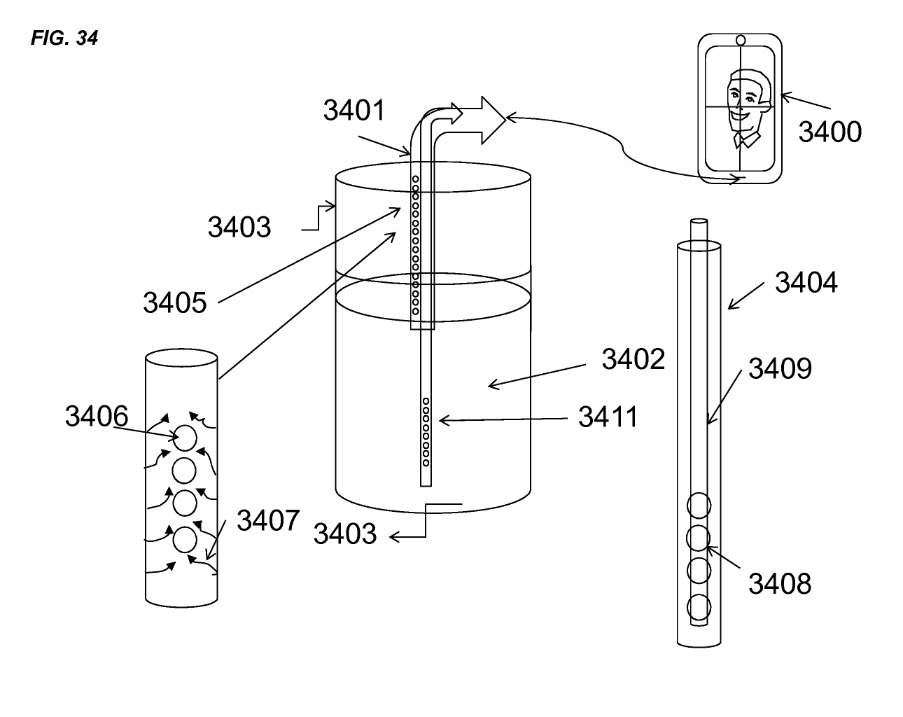

Now referring to FIG. 34 a mobile device or smartphone 3400 can be connected to a probe sensor 3401. The probe sensor 3401 is comprised of the liquid sensor rod 3405 and tip 3404 for analyzing liquid specimens 3402 when placed in a glass cup 3403. The rod 3401 contains air suction holes 3406 and cilia fibers 3407 in a tube 3405 for vapor testing electronically. A liquid sensor device 3404 is located at the tip 3411 of the rod 3401 and an air vapor sensor at the top 3405 of the rod 3410. Liquid suction holes 3408 of the liquid test probe are located at the tip 3411 of the rod.

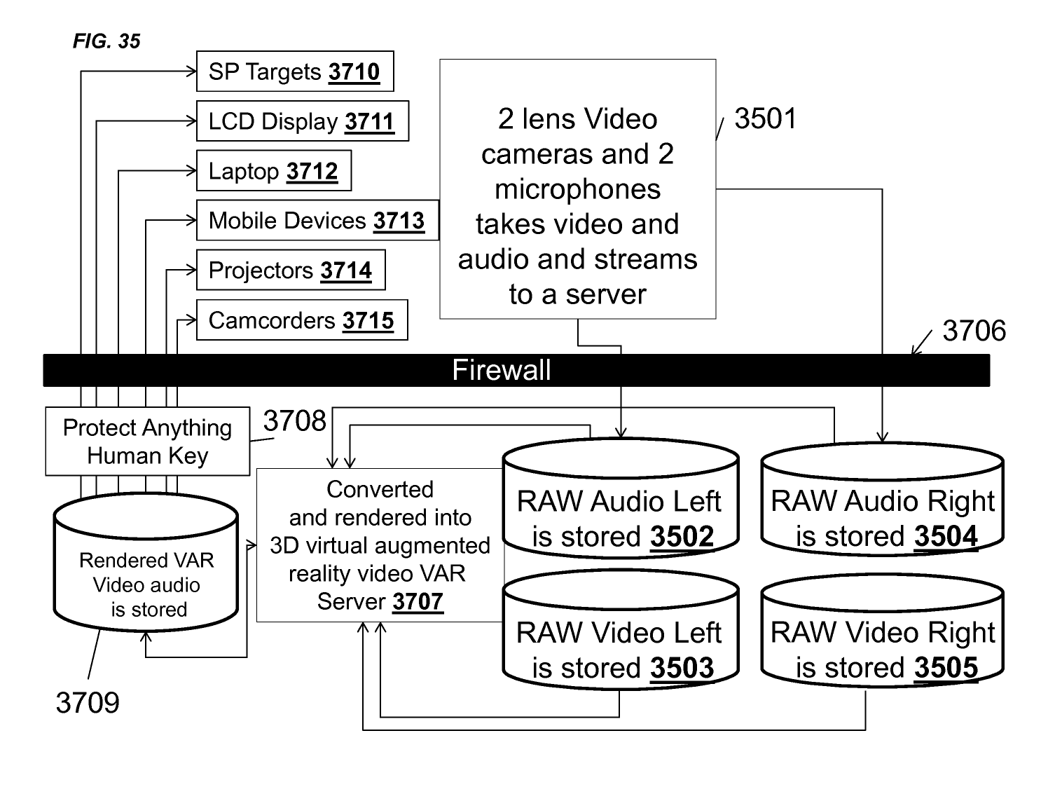

Now referring to FIG. 35, flow of information through the system and apparatus is shown. First a mobile device equipped with a two lens video camera and two microphone device captures video and audio that is sent to a system server 3501. Raw left and right audio is stored in respective databases 3502 and 3503 as is raw left and right video is stored in respective databases 3504 and 3505 behind a firewall 3506. The data is converted and rendered into a 3D video 3507 by a VAR server. Rendered video and audio is stored in a database 3509. The human key 3708 then provides access to the rendered VAR video and audio 3507 to electronic devices and machines such as SP targets 3510, LCD displays 3511, laptops 3512, mobile devices 3513, projectors 3514, and camcorders 3515 across the firewall 3506 upon request by a verified using having permission to access the rendered VAR video and audio 3507 as verified by the human key 3508.

Moreover, other implementations of the invention will be apparent to those skilled in the art from consideration of the specification and practice of the invention disclosed herein. Various aspects and components of the described embodiments may be used singly or in any combination in the computerized content filtering system. It is intended that the specification and examples be considered as exemplary only, with a true scope and spirit of the invention being indicated by the following claims.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An apparatus for human identification; registration; and protection executed in combination by a mobile device and a computer comprising:
a mobile device consisting of a camera for capturing and recording video and audio data;
a server for receiving video streamed to it by the mobile device for sign-up or sign-in;
working from a computer or mobile device 4 and using an Internet connection;
accessing an authentication unit the authentication unit creating data for registration the authentication unit also creating identification data; and
sending to verification; a match combined with 9 out of 17 positive point evaluations returns, via an Internet connection to the mobile device.

2. The apparatus of claim 1, wherein
the authentication unit creating data for registration by:
converting video to .jpg image files;
converting .jpg image files to ASCII PPM files;
converting PPM files to CODEFA files;
converting CODEFA file into wave form for analysis;
converting CODEFA file into interpolated brightness variables;
creating wave form coordinates and pixel data;
storing files in a first data storage and numerical data in a second data storage location;
the authentication unit creating identification data by:
converting video to .jpg image files;
converting .jpg image files to ASCII PPM files;
converting PPM files to CODEFA files;
converting CODEFA files into wave form for analysis;
converting CODEFA file into interpolated brightness variables;
creating wave form coordinates and pixel data;
storing files in a first data storage and numerical data in a second data storage and comparing the first data to the second date using a Computer Object De-Encryption Encryption File Algorithm (CODEFA); and
sending to verification; a match combined with 9 out of 17 positive point evaluations returns, via an Internet connection to the mobile device.

3. The apparatus of claim 1, wherein the device is a smartphone comprised of
a front cam, back dual cams and a back single cam with a projector for VAR projection and virtual movement detection;
one or more microphones;
means capable of audio voice print identification;
means capable of video color pixel field identification 3D analysis focus point; and
means capable of VAR or flat field projection.

4. The apparatus of claim 1, wherein the device is a smartphone comprised of
one cam split or two cams in 3D mode;
two stereo microphones; and
projector means comprised of two separate CCDs with two separate mirrors.

5. The apparatus of claim 1, wherein the device is a smartphone comprised of a projector means comprised of two a single CCD with split mirrors.

6. The apparatus of claim 1, wherein the device is a smartphone comprised of a cam and microphone and crosshairs on a display screen with one cam in front creating a single cam identification embodiment of the apparatus.

7. The apparatus of claim 1, wherein the device is a smartphone comprised of
dual cameras and dual projection lenses;
a dual CCD 3D VAR video projection device comprised of two mirrors associated with one of the two CCDs for projecting an image out of the projector.

8. The apparatus of claim 2, wherein
the authentication unit creating data for registration 504 by:
extracting audio from video and converting to Wave form;
creating a point grid for analysis;
creating a form coordinates;
creating numerical reference points;
converting data into interpolated volume variables;
storing wave form coordinates and volume data; and
storing files in a first data storage and numerical data in a second data storage;
the authentication unit also creating data for identification by:
extracting audio from video and converting to Wave form;
creating point grid for analysis; creating wave form coordinates creating numerical reference points;
converting data into interpolated volume variables;
storing form coordinates and volume data; storing files in a first data storage and numerical data in a second data storage; and
comparing data stored in the databases in step and sending to verification by CODEFA.

9. The apparatus of claim 2, wherein
the authentication unit creating data for registration by:
extracting 24 images at beginning of audio;
extracting 24 images at 2 second mark of audio start;
extracting 24 images backward at end of audio stop;
converting files into wave form for analysis;
converting files into interpolated brightness variables;
creating wave form coordinates and pixel data; and
storing files in a first data storage and numerical data in a second data storage;
the authentication unit also creating data for identification by:
extracting 24 images at beginning of audio;
extracting 24 images at 2 second mark of audio start;
extracting 24 images backward at end of audio stop;
converging into wave form for analysis; converting files into interpolated brightness variables;
creating wave form coordinates and pixel data;
storing file in a first data storage and numerical data in a second data storage; and
comparing data stored in the databases in step and sending to verification by CODEFA.

10. The apparatus of claim 2, wherein
The authentication unit creating data for registration by:
extracting form the video 3 image files at random times; converting .jpg image files to ASCII PPM files;
converting PPM files to CODEFA files;
converting CODEFA file into wave form for analysis; converting CODEFA file into interpolated brightness variables;
creating wave form coordinates and pixel data; and storing files in a first data storage and numerical data in a second data storage;
the authentication unit also creating data for identification by:
extracting from video three image files at random times;
converting .jpg image files to ASCII PPM files;
converting PPM files to CODEFA files;
converting CODEFA file into wave form for analysis;
converting CODEFA file into interpolated brightness variables;
creating wave form coordinates and pixel data; storing files in a first data storage and numerical data in a second data storage; and
comparing data stored in the databases and sending to verification by CODEFA.

11. The apparatus of claim 2, wherein
the authentication unit creating data for registration by:
converting video to .jpg image files;
converting .jpg image files to ASCII PPM files;
converting PPM files to CODEFA files;
converting CODEFA file into wave form for analysis;
converting CODEFA file into interpolated brightness variables;
creating wave form coordinates and pixel data; creating 6 additional levels or brightness + and −;
storing files in a first data storage and numerical data in a second data storage;
the authentication unit also creating data for identification by:
converting video to .jpg image files;
converting .jpg image files to ASCII PPM files;
converting PPM files to CODEFA files;
converting CODEFA file into wave form for analysis; converting CODEFA file into interpolated brightness variables;
creating wave form coordinates and pixel data;
creating six additional levels or brightness + and −;
storing files in a first data storage and numerical data in a second data storage;
comparing data stored in the databases and sending to verification by CODEFA.

12. The apparatus of claim 2, wherein
the authentication unit creating data for registration by:
verifying video and audio are stored;
processing video and audio into CODEFA;
During verification state Video and Audio spatial point is recorded from microphone and camera lenses;
storing files in a first data storage and numerical data in a second data storage;
the authentication unit also creating data for identification by:
verifying video and audio are stored;
processing video and audio into CODEFA;
During verification state Video and Audio SP spatial point is recorded from microphone and camera lenses; storing files in a first data storage and numerical data in a second data storage;
During identification CODEFA Registration SP data is compared to CODEFA Identification SP data to see if it matches;
comparing data and send to verification; and
if match data is stored as + data for learning;
if no match data is stored as − data for learning and the video data is analyzed for a match of who the user really is, and if identified;
notifies user by email questioning the failed identification.

13. The apparatus of claim 2, wherein
The authentication unit creating data for registration by:
extracting audio from video and converting to Wave form;
creating point grid for analysis; creating wave form coordinates; creating numerical reference points; converting data into interpolated volume variables; storing wave form coordinates and volume data from audio phrase begin point to end point; and storing files in a first data storage and numerical data in a second data storage;
The authentication unit also creating data for identification by:
extracting audio from video and converting to Wave form;
creating point grid for analysis; creating wave form coordinates;
creating numerical reference points; c
converting data into interpolated volume variables;
storing wave form coordinates and volume data from audio phrase begin point to end point; and
storing files in a first data storage and numerical data in a second data storage; comparing data and sending to verification by CODEFA.

14. The apparatus of claim 2, wherein
the authentication unit creating data for registration by:
receiving processor data during registration;
receiving processor time of day related to registration;
receiving typed phrase during registration;
receiving audio file of phrase spoken at CODEFA during registration;
converting CODEFA file into interpolated volume variables with SP Target data embedded;
creating wave form coordinates and pixel data;
storing files in a first data storage and numerical data in a second data storage;
the authentication unit also creating data for identification by:
receiving processor data during registration;
receiving processor time of day related to registration;
receiving typed phrase during registration;
receiving audio file of phrase spoken at CODEFA during registration;
converting CODEFA file into interpolated volume variables with SP Target data embedded;
creating wave form coordinates and pixel data; storing files in a first data storage and numerical data in a second data storage;
comparing data and sending to verification by CODEFA.

15. The apparatus of claim 2, wherein
the authentication unit creating data for registration by:
converting dual cam video to .jpg image files with SP Target of each cam embedded;
converting .jpg image files to ASCII PPM files;
converting PPM files to CODEFA files;
converting CODEFA file into wave form for analysis; converting CODEFA file into interpolated brightness variables;
creating wave form coordinates and pixel data; storing files in a first data storage and numerical data in a second data storage;
the authentication unit also creating data for identification by:
converting dual cam video to .jpg image files with SP Target of each cam embedded;
converting .jpg image files to ASCII PPM files;
converting PPM files to CODEFA files;
converting CODEFA file into wave form for analysis; converting CODEFA file into interpolated brightness variables;
creating wave form coordinates and pixel data;
storing files in a first data storage and numerical data in a second data storage;
comparing data and sending to verification by CODEFA.

16. The apparatus of claim 2, wherein
The authentication unit creating data for registration Automatic Object Identification, views background compared with foreground and attaches box around moving object with 16 pixels distance around the edge, locks on, gets image for beginning of processing then:
converting video to .jpg image files;
converting .jpg image files to ASCII PPM files;
converting PPM files to CODEFA files;
converting CODEFA file into wave form for analysis;
converting CODEFA file into interpolated brightness variables; creating wave form coordinates and pixel data; and storing files in a first data storage and numerical data in a second data storage;
the authentication unit also creating data for identification by Automatic Object Identification then:
converting video to .jpg image files;
converting .jpg image files to ASCII PPM files;
converting PPM files to CODEFA files;
converting CODEFA file into wave form for analysis;
converting CODEFA file into interpolated brightness variables;
creating wave form coordinates and pixel data;
storing files in a first data storage and numerical data in a second data storage;
comparing data and sending to verification by CODEFA.

17. The apparatus of claim 2, wherein
the authentication unit creating data for registration by:
using an audio phrase distance device comprised of on the phone or device;
sending data back to the main server for evaluation and decision to determine distance to object using sound and infrared data;
converting variation calculated with audio phrase distance and distance data to object data; storing files in a first data storage and numerical data in a second data storage and audio phrase distance data in a third data storage;
the authentication unit also creating data for identification by:
using an audio phrase distance device to determine Distance to object using sound and infrared data;
converting variation calculated with audio phrase distance and distance data to object data;
storing files in a first data storage, numerical data in a second data storage, and audio phrase distance data in a third data storage;
using stored values for comparison with audio data; and
determining identification at different distances from microphone.

18. The apparatus of claim 2, wherein
the authentication unit creating data for registration by:
converting 3D multiple cam video to .jpg image files;
converting .jpg image files to ASCII PPM files;
converting PPM files to CODEFA files;
converting CODEFA file into wave form for analysis;
converting CODEFA file into interpolated brightness variables;
creating wave form coordinates and pixel data;
storing files in a first data storage and numerical data in a second data storage;
the authentication unit also creating data for identification by:
converting dual cam video to .jpg image files with SP Target of each cam embedded;
converting .jpg image files to ASCII PPM files;
converting PPM files to CODEFA files;
converting CODEFA file into wave form for analysis; c converting CODEFA file into interpolated brightness variables;
creating wave form coordinates and pixel data; storing files in a first data storage and numerical data in a second data storage;
comparing 3D differences and store in 3D data storage;
comparing data in a first data storage and numerical data in a second data storage;
comparing the data and sending to verification.

19. The apparatus of claim 2, wherein
the authentication unit creating data for registration by:
converting video to .jpg image files in grayscale;
converting .jpg image files to ASCII PPM files;
converting PPM files to CODEFA files;
converting CODEFA file into wave form for analysis;
converting CODEFA file into interpolated brightness variables;
creating wave form coordinates and pixel data; and
storing files in a first data storage and numerical data in a second data storage;
the authentication unit also creating data for identification by:
converting video to .jpg image files in grayscale;
converting .jpg image files to ASCII PPM files;
converting PPM files to CODEFA files;
converting CODEFA file into wave form for analysis;
converting CODEFA file into interpolated brightness variables;
creating wave form coordinates and pixel data; storing files in a first data storage 1606 and numerical data in a second data storage; and
comparing data stored in the databases and send to verification.

20. The apparatus of claim 2, wherein
the authentication unit creating data for registration by:
converting video to .jpg image files;
converting .jpg image files to ASCII PPM files;
converting PPM files to CODEFA files;
converting CODEFA file into wave form for analysis;
converting CODEFA file into interpolated brightness variables;
creating wave form coordinates and pixel data PCB;
storing files in a first data storage land numerical data in a second data storage;
the authentication unit also creating data for identification by:
converting video to .jpg image files;
converting .jpg image files to ASCII PPM files;
converting PPM files to CODEFA files;
converting CODEFA file into wave form for analysis;
converting CODEFA file into interpolated brightness variables;
creating wave form coordinates and pixel data PCB;
storing files in a first data storage and numerical data in a second data storage;
comparing data stored in the databases using CODEFA.

21. The apparatus of claim 2, wherein
the authentication unit creating data for registration by:
converting audio from two stereo microphones to data;
converting audio data and input into database;
analyze and compare left data from right data;
storing files in a first data storage and numerical data in a second data storage;
the authentication unit creating data for identification by:
converting audio from two stereo microphones to data;
converting audio data and input into databases;
analyzing and comparing left date from right data;
storing files in a first data storage and numerical data in a second data storage;
comparing data stored in the databases in step using CODEFA.

22. The apparatus of claim 2, wherein
The authentication unit creating data for registration by:
converting video to .jpg image files;
converting file into interpolated brightness variables; converting .jpg image files to Vector files;
converting Vector Files to line art; overlaying Line art on to grid form for analysis; creating grid form coordinates and pixel data PCB;
storing files in a first data storage and numerical data in a second data storage;
the authentication unit creating data for identification by:
converting video to .jpg image files;
converting file into interpolated brightness variables;
converting .jpg image files to Vector files; converting Vector Files to line art;
overlaying Line art on to grid form for analysis;
creating grid form coordinates and pixel data PCB;
storing files in a first data storage and numerical data in a second data storage;
comparing data in step using CODEFA.

23. The apparatus of claim 2, wherein
the authentication unit creating data for registration by:
converting video to .jpg image files;
converting file into interpolated brightness variables;
converting .jpg image files to vector files;
converting vector files to line art;
overlaying line art on to grid form for analysis;
creating grid form coordinates and pixel data PCB; and
storing files in a first data storage and numerical data in a second data storage;
the authentication unit creating data for identification by:
converting video to .jpg image files;
converting file into interpolated brightness variables;
converting .jpg image files to Vector files;
converting Vector Files to line art;
overlaying line art on to grid form for analysis;
creating grid form coordinates and pixel data PCB;
storing files in a first data storage and numerical data in a second data storage;
comparing data stored in the databases using CODEFA.

24. The apparatus of claim 2, wherein
the authentication unit creating data for registration by:
converting 3D multiple cam video to .jpg image files;
converting .jpg image files to ASCII PPM files;
converting PPM files to CODEFA files;
converting CODEFA file into wave form for analysis;
converting CODEFA file into interpolated brightness variables;
creating wave form coordinates and pixel data; and
storing files in a first data storage and numerical data in a second data storage;
the authentication unit creating data for identification by:
converting dual cam video to .jpg image files with SP Target of each cam embedded;
converting .jpg image files to ASCII PPM files;
converting PPM files to CODEFA files;
converting CODEFA file into wave form for analysis;
converting CODEFA file into interpolated brightness variables;
creating wave form coordinates and pixel data; storing files in a first data storage and numerical data in a second data storage;
comparing 3D differences and store in 3D data storage;
comparing data and send to verification using CODEFA.

25. The apparatus of claim 2, wherein
The authentication unit creating data for registration by:
converting video to .jpg image files in grayscale;
converting .jpg image files to ASCII PPM files;
converting PPM files to CODEFA files;
converting CODEFA file into wave form for analysis;
converting CODEFA file into interpolated brightness variables;
creating wave form coordinates and pixel data;
storing files in a first data storage and numerical data in a second data storage;
the authentication unit creating data for identification by:
converting video to .jpg image files in grayscale;
converting .jpg image files to ASCII PPM files;
converting PPM files to CODEFA files;
converting CODEFA file into wave form for analysis;
converting CODEFA file into interpolated brightness variables;
creating wave form coordinates and pixel data; storing files in a first data storage and numerical data in a second data storage;
comparing V1 data to V2 data sending to verification using CODEFA.

26. The apparatus of claim 2, wherein
the authentication unit creating data for registration by:
converting dual cam video to .jpg image files with SP Target of each cam embedded;
converting .jpg image files to ASCII PPM files;
converting PPM files to CODEFA files;
converting CODEFA file into wave form for analysis;
converting CODEFA file into interpolated brightness variables;
creating wave form coordinates and pixel data; storing files in a first data storage and numerical data in a second data storage;
the authentication unit creating data for identification by:
converting dual cam video to .jpg image files with SP Target of each cam embedded;
converting .jpg image files to ASCII PPM files;
converting PPM files to CODEFA files;
converting CODEFA file into wave form for analysis;
converting CODEFA file into interpolated brightness variables;
creating wave form coordinates and pixel data;
storing files in a first data storage and numerical data in a second data storage;
comparing data in step and sending to verification using CODEFA.

27. The apparatus of claim 2, wherein
the authentication unit creating data for registration by Automatic Object Identification, views background compared with foreground and attaches box around moving object with 16 pixels distance around the edge, locks on, gets image for beginning of processing then:
converting video to .jpg image files;
converting .jpg image files to ASCII PPM files;
converting PPM files to CODEFA files;
converting CODEFA file into wave form for analysis;
converting CODEFA file into interpolated brightness variables;
creating wave form coordinates and pixel data; and
storing files in a first data storage and numerical data in a second data storage;
the authentication unit creating data for identification by Automatic Object Identification then:
converting video to .jpg image files;
converting .jpg image files to ASCII PPM files;
converting PPM files to CODEFA files;
converting CODEFA file into wave form for analysis;
converting CODEFA file into interpolated brightness variables;
creating wave form coordinates and pixel data;
storing files in a first data storage and numerical data in a second data storage;
comparing data stored in the databases and sending to verification via CODEFA.

28. The apparatus of claim 2, wherein
the authentication unit creating data for registration by:
extracting from video 3 image files at random times;
converting .jpg image files to ASCII PPM files;
converting PPM files to CODEFA files;
converting CODEFA file into wave form for analysis;
converting CODEFA file into interpolated brightness variables;
creating wave form coordinates and pixel data; and
storing files in a first data storage and numerical data in a second data storage;
the authentication unit creating data for identification by:
extracting from video 3 image files at random times;
converting .jpg image files to ASCII PPM files;
converting PPM files to CODEFA files;
converting CODEFA file into wave form for analysis;
converting CODEFA file into interpolated brightness variables;
creating wave form coordinates and pixel data;
storing files in a first data storage and numerical data in a second data storage;
comparing data stored in the databases and sending to verification using CODEFA.

29. The apparatus of claim 2, wherein
the authentication unit creating data for registration by:
converting video to .jpg image files;
converting .jpg image files to ASCII PPM files;
converting PPM files to CODEFA files;
converting CODEFA file into wave form for analysis;
converting CODEFA file into interpolated brightness variables;
creating wave form coordinates and pixel data; creating 6 additional levels or brightness + and −;
storing files in a first data storage and numerical data in a second data storage;
the authentication unit creating data for identification by:
converting video to .jpg image files;
converting .jpg image files to ASCII PPM files; converting PPM files to CODEFA files;
converting CODEFA file into wave form for analysis; converting CODEFA file into interpolated brightness variables;
creating wave form coordinates and pixel data; creating 6 additional levels or brightness + and −;
storing files in a first data storage and numerical data in a second data storage;
comparing stored data and sending it to verification.
